(19) United States
(12) Patent Application Publication
(10) Pub. No.: US 2005/0013592 A1
(43) Pub. Date: Jan. 20, 2005

(54) Device and method for reproducing sound and motion picture

(76) Inventors: Masaya Umemura, Yokosuka (JP); Kazushige Hiroi, Machida (JP); Shinichiro Okamura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/650,749

(22) Filed: Aug. 29, 2003

(30) Foreign Application Priority Data
Jul. 15, 2003 (JP) 2003-197247

(51) Int. Cl. H04N 5/76

(52) U.S. Cl. 386/96; 386/94

(57) ABSTRACT

A reproducing apparatus is provided. According to that reproducing apparatus, separately provided sound data and motion picture data coincide with each other in reproducing start timing with smaller discrepancy than the conventional techniques.

The reproducing apparatus 1 synchronously reproduces separately provided motion picture data and sound data, comprising a motion picture reproducing unit 40 and a sound reproducing unit 50. The motion picture reproducing unit 50 includes a motion picture decoder 42 which decodes the motion picture data and a display control unit 44 which converts the motion picture data decoded by the motion picture decoder into an image signal for a display unit, to output the image signal to the display unit 60. The sound reproducing unit 50 includes a sound decoder 52 which decodes the sound data, a PCM data buffer 53 which stores the sound data decoded by the sound decoder 52, and a digital-analog converter 54 which converts the decoded sound data stored in the data buffer into a sound signal for a speaker, to output the sound signal to the speaker 71.

This application is based on Japanese Patent Application No. 2003-197247 filed in Japan, the contents of which are incorporated hereinto by reference.

### BACKGROUND OF THE INVENTION

The present invention relates to a technique of reproducing motion picture data and sound data provided separately from each other.

Usually, multimedia data distributed through a network consists of header information and a payload. The payload includes motion picture data and sound data alternately, each piece of data being added with synchronous information. As multimedia data having such a configuration, may be mentioned a program stream or a transport stream of the MPEG1 format or the MPEG2 format, for example.

The patent document 1 (Japanese Non-examined Patent Laid-Open No. 8-172606) discloses a system in which MPEG1 format or MPEG2 format motion picture data with sound are accumulated in a reproducing apparatus and then reproduced.

Further, the patent document 2 (Japanese Non-examined Patent Laid-Open No. 7-095522) discloses a reproducing system in which sound data and motion picture data are accumulated separately and then reproduced. Usually, in comparison with sound data, motion picture data are larger in quantity to process for reproducing. Thus, sometimes, output of reproduced motion picture data is delayed from output of reproduced sound data. In such a case, the mentioned reproducing system discards some frames of motion picture data at certain time intervals, without reproducing them. Then, a motion picture decoder is instructed to advance the time of frames, to reproduce the frames in conformity with the reproducing time of the sound data. Thus, by lowering the frame rate intentionally, time discrepancy between reproduced sound and reproduced images is cancelled, and sound and images are synchronized.

### SUMMARY OF THE INVENTION

In the reproducing system described in the patent document 1, motion picture data are added with sound data in advance. Thus, it is not assumed that sound data and corresponding motion picture data are purchased separately, and stored into the reproducing apparatus. Thus, it is not considered at all how the sound data and the motion picture data are reproduced synchronously in that case.

Further, in the case of the patent document 2, when separately accumulated sound data and motion picture data are reproduced, the sound data and the motion picture data are synchronized by advancing the time of frames of the motion picture data in conformity with the reproducing time of the sound data and lowering the frame rate of the motion picture data. However, difference in reproducing processing time of the decoder of the sound data and the decoder of the motion picture data brings discrepancy between outputs of the decoders. Accordingly, for a period of time extending from the start of reproducing to an instruction to the motion picture decoder to lower the frame rate, discrepancy between the sound data and the motion picture data is not cancelled. Further, the patent documents 1 and 2 do not take it into consideration to reproduce both sound data and motion picture data when separately provided sound data and motion picture data are protected by different license keys.

The present invention has been made taking the above-described state into consideration. The present invention provides reproducing output start timings of separately provided sound data and motion picture data, which are coincident with each other such that discrepancy between those timings become smaller in comparison with the conventional techniques. Further, the present invention also provides sound data and motion picture data to produce, which are protected by different license keys respectively.

To solve the above-described problems, a reproducing apparatus according to the present invention includes a motion picture reproducing unit and a sound reproducing unit, and performs synchronous reproducing of motion picture data and sound data provided separately from each other. Further, the motion picture reproducing unit decrypts encrypted motion picture data, and the sound reproducing unit decrypts encrypted sound data. At that time, reproducing output start timing of the sound data is made coincide with the start of reproducing output of the motion picture data.

For example, the reproducing apparatus according to the present invention is a reproducing apparatus which synchronously reproduces motion picture data and sound data provided separately from each other, and includes a motion picture reproducing unit and a sound reproducing unit. The motion picture reproducing unit includes: a motion picture decoder which decodes said motion picture data; and a display control unit which converts the motion picture data decoded by said motion picture decoder into an image signal for a display unit, and which outputs the image signal to said display unit. The sound reproducing unit includes: a sound decoder which decodes said sound data; a data buffer which stores the sound data decoded by said sound decoder; and a sound conversion means which converts the decoded sound data stored in said buffer into a sound signal for a sound device, and outputs the sound signal to said sound device. The display control means asserts a synchronous reproducing start signal according to output of said image signal corresponding to a top frame of said motion picture data. The sound conversion means starts output of said sound signal according to assert of said synchronous reproducing start signal.

Further, the reproducing apparatus of the present invention obtains license keys of motion picture data and sound data provided separately from each other, and uses the obtained license keys to decrypt the motion picture data and sound data respectively, to reproduce the decrypted motion picture data and sound data.

For example, the reproducing apparatus of the present invention is a reproducing apparatus which reproduces a content having motion picture data and sound data provided separately from each other, and includes a motion picture reproducing unit, a sound reproducing unit, and a communication unit. The communication unit includes: a license key obtaining means which sends identification information of a content to a content providing device through a network, to obtain a sound license key of sound data and a motion picture license key of motion picture data from said content providing device; and a license key storing means which stores the sound license key and the motion picture license key obtained by said license key obtaining means. The motion picture reproducing unit includes: a motion picture decryptor which decrypts encrypted motion picture data by using the motion picture license key stored in said license key storing means; a motion picture decoder which decodes the motion picture data decrypted by said motion picture decryptor; and a display control means which converts the motion picture data decoded by said motion picture decoder into an image signal for a display unit, and outputs the image signal to said display unit. The sound reproducing unit includes: a sound decryptor which decrypts encrypted sound data by using the sound license key stored in said license key storing means; a sound decoder which decodes the sound data decrypted by said sound decryptor; and a sound conversion means which converts the sound data decoded by said sound decoder into a sound signal for a sound device, and outputs the sound signal to said sound device.

### BRIEF DESCRIPTION OF THE DRAWINGS

FIG. 1 is a diagram showing functional blocks of an MCMP (multi carrier media player) according to an embodiment of the present invention;

FIG. 2 is a diagram showing a configuration of functional components of an MCMP according to an embodiment of the present invention;

FIG. 3 is a view showing an outward appearance of an MCMP according to an embodiment of the present invention;

FIGS. 4A, 4B and 4C are diagrams schematically showing clipping mode reproducing and repeat mode reproducing according to an embodiment of the present invention;

FIG. 5 is a diagram showing an average calculator of an MCMP according to an embodiment of the present invention;

FIGS. 6A and 6B are diagrams schematically showing reproducing of sound data and motion picture data having different reproducing times, according to an embodiment of the present invention;

FIGS. 7A and 7B are diagrams showing an example of a method of storing sound data and motion picture data, according to an embodiment of the present invention;

FIGS. 8A and 8B are diagrams showing an example of a method of managing sound data and motion picture data, according to an embodiment of the present invention;

FIGS. 9A, 9B and 9C are diagrams showing an example of a method of managing license information, according to an embodiment of the present invention;

FIG. 10 is a diagram showing a processing flow in first content retrieval according to an embodiment of the present invention;

FIG. 11 is a diagram showing a processing flow in second content retrieval according to an embodiment of the present invention;

FIGS. 12A and 12B are views showing examples of a display screen at the time of reproducing sound data or motion picture data, according to an embodiment of the present invention;

FIGS. 13A, 13B and 13C are views showing examples of a display screen for searching for a content, according to an embodiment of the present invention;

FIGS. 14A, 14B and 14C are views showing examples of a display screen for purchasing a content, according to an embodiment of the present invention;

FIGS. 15A, 15B and 15C are views showing examples of a display screen when an MCMP 1 according to an embodiment of the present invention is connected to a personal computer; and

FIG. 16 is a diagram showing a configuration of functional components in the case where an MCMP according to an embodiment of the present invention is made to function as a mobile phone.

### DETAILED DESCRIPTION OF THE PREFERRED EMBODIMENTS

Now, an embodiment of the present invention will be described.

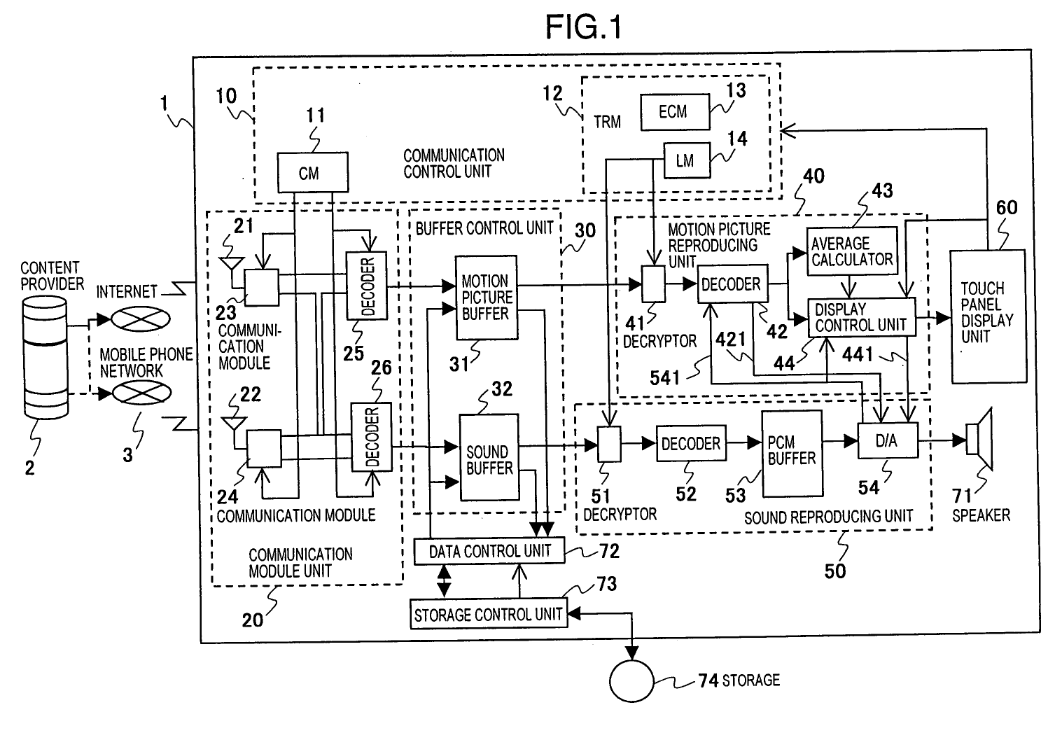

FIG. 1 is a diagram showing functional blocks of a multi carrier media player 1 according to an embodiment of the present invention. Hereinafter, a multi carrier media player 1 is referred to as an MCMP 1.

As shown in the figure, the MCMP 1 includes a communication control unit 10, a communication module unit 20, a buffer control unit 30, a motion picture reproducing unit 40, a sound reproducing unit 50, a data control unit 72 which controls a data path of motion picture data or sound data, and a storage control unit 73 which controls read and write to a storage 74 mounted on the MCMP 1.

The MCMP 1 further includes a touch panel display unit 60 such as a liquid crystal display or an organic EL (electroluminescence) display, and a speaker 71, as peripheral equipment. Here, as the storage 74 mounted on the MCMP 1, may be used an exchangeable storage medium such as an MD (mini disk) or a DVD. As a result, data can be read and written by replacing a storage 74 if necessary, without connecting it fixedly to the MCMP 1 such as a hard disk. In the present embodiment, an MD is used as a storage 74, although the present invention is not limited to it.

The communication control unit 10 includes a communication manager (hereinafter, referred to as CM) 11 which manages communication, and a tamper resistance module (hereinafter, referred to as TRM) 12 which stores data having a property (tamper resistance) that the data destroy themselves when it is tried to read the data illegally. The TRM 12 includes an electronic commerce manager (hereinafter, referred to as ECM) 13 which performs electronic commerce, and a license manager (hereinafter, referred to as LM) 14 which performs license management of motion picture data or sound data.

The communication module unit 20 includes a wireless LAN antenna 21, a wireless LAN communication module 23, a mobile phone network antenna 22, a mobile phone network communication module 24, a motion picture data decoder 25 which decodes motion picture data when the motion picture data encoded and distributed through a network are received, and a sound data decoder 26 which decodes sound data when the sound data encoded and distributed through the network are received.

The buffer control unit 30 includes a motion picture buffer 31 and a sound buffer 32.

The motion picture reproducing unit 40 includes a motion picture decryptor 41 which decrypts motion picture data (which are protected (encrypted) by a copyright protection technique) using a license key, a motion picture decoder 42 which expands (decodes) picture data that have been compressed (encoded), an average calculator 43 which calculates an average of a luminance signal (a y value) of motion picture data, and a display control unit 44 which controls display of motion picture data.

The sound reproducing unit 50 includes a sound decryptor 51 which decrypts sound data (which are protected (encrypted) by a copyright protection technique) using a license key, a sound decoder 52 which expands (decodes) sound data (which have been compressed (encoded)) into a PCM signal (pulse code modulation), a PCM buffer 53 which accumulates the output (PCM signal) of the sound decoder 52, and a digital-analog converter 54.

FIG. 1 shows also various networks 3 such as Internet and a mobile phone network and a content provider 2 that distributes motion picture data or sound data to the MCMP 1 through the various networks.

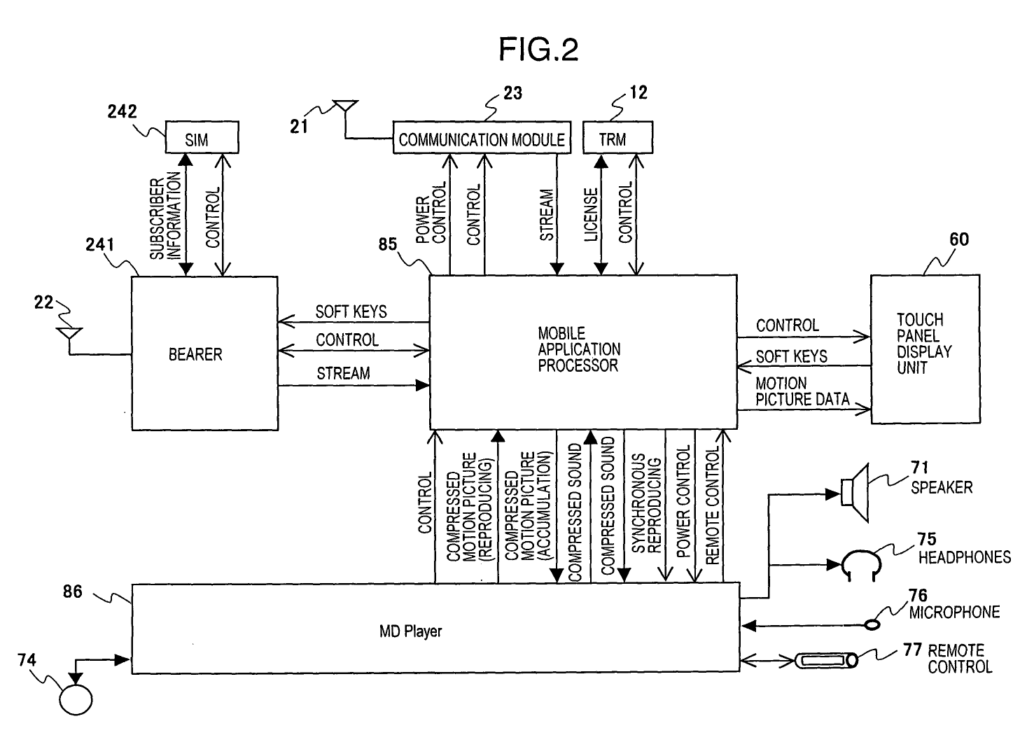

FIG. 2 shows a configuration of functional components of the MCMP 1 shown in FIG. 1. In FIG. 2, the functional blocks of the MCMP 1 are shown in blocks of a functional component (so-called chip).

The MCMP 1 includes a bearer 241, a SIM (subscribe identity module) 242, the wireless LAN communication module 23, the TRM 12, a mobile application processor 85 which controls the whole of the MCMP 1 and which reproduces a motion picture, and an MD player 86.

The bearer 241 and the SIM 242 correspond to the mobile phone network communication module 24 (FIG. 1). The bearer 241 distinguishes between ordinary voice communication and data communication before starting communication, and performs communication processing according to the result of the distinguishment. This can make voice communication and data communication coexist by one subscriber number. The SIM 242 is an IC card that stores subscriber information of a mobile phone. The SIM 242 delivers the subscriber information to the bearer 241, and the bearer 241 uses the subscriber information to connect with the mobile phone network. Thus, the MCMP 1 can perform voice communication or data communication with an external system. To connect with the mobile phone network, the mobile phone network antenna 22 is used.

The mobile application processor 85 corresponds to the CM 11, the buffer control unit 30, the data control unit 72 and the motion picture reproducing unit 40 shown in FIG. 1, and controls the whole of the MCMP 1 and reproduces a motion picture.

The MD player 86 corresponds to the sound reproducing unit 50 and storage control unit 73, and reads and writes data to an MD as a storage 74, according to an instruction inputted from the mobile application processor 85 or a remote control 77. The MD player 86 is connected with a speaker 71, headphones 75, a microphone 76, the remote control 77, and the like.

The mobile application processor 85 receives various instructions inputted from soft keys of the touch panel display unit 60, and sends a soft key or a control signal to a functional component shown in FIG. 2, according to the received instruction.

To communicate with an external system through the mobile phone network, the mobile application processor 85 sends a soft key or a control signal to the bearer 241. The bearer 241 receives various contents (streams) downloaded through the mobile phone network, and delivers the contents together with a control signal to the mobile application processor 85.

To communicate with an external system through Internet, the mobile application processor 85 sends a control signal to the wireless LAN communication module 23, and receives various contents (streams) from the wireless LAN communication module 23. The mobile application processor 85 sends a power control signal to the wireless LAN communication module 23, to save power consumption at the time of non-connection with Internet.

The mobile application processor 85 sends a control signal to the TRM 12, to store or read a license key. Further, the mobile application processor 85 outputs motion picture data together with a control signal to the touch panel display unit 60, based on an instruction inputted through a soft key.

Then, the mobile application processor 85 sends motion picture data stored in a storage 74 (MD) and various control signals to the MD player 86, and reads motion picture data stored in a storage 74. Similarly, the mobile application processor 85 stores or reads sound data. Further, the mobile application processor 85 sends a reproducing signal to the MD player 86 at the time of synchronous reproducing of motion picture data and sound data. Further, the MD player 86 sends a reproducing signal to the mobile application processor 85 at the time of synchronous motion picture data and sound data. Further, a mobile application processor 85 sends a power control signal to the MD player 86 to save power consumption at the time when the MD player 86 is not used. Further, the MD player 86 sends a command received from the remote control 77 to the mobile application processor 85 if necessary.

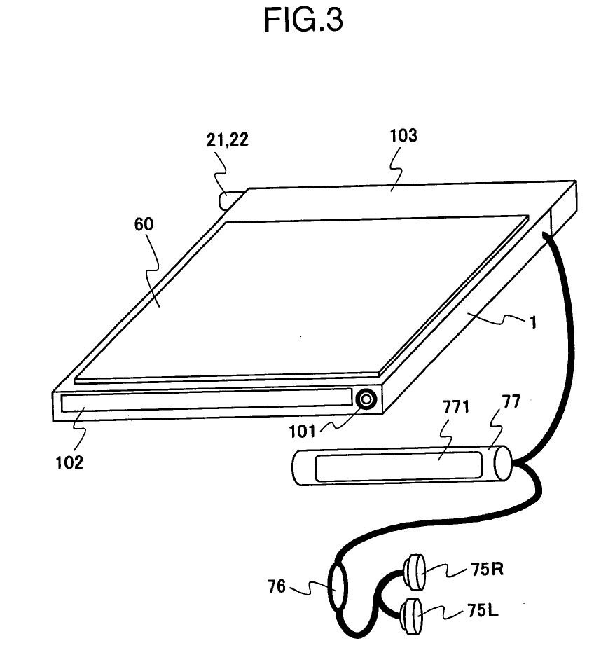

FIG. 3 shows an outward appearance of the MCMP 1. As shown, the MCMP 1 is connected with the remote control 77, the headphones 75R and 75L which output sound, and the microphone 76 which inputs sound. The microphone 76 is connected between the remote control 77 and the headphones 75R and 75L. Further, the remote control 77 includes a display unit 771 which displays a communication state, a reproducing state, or the like, and an input unit not shown such as a button or a jog dial.

A main body of the MCMP 1 includes the touch panel display unit 60 on its upper surface. Further, there exist an insertion slot 102 which inserts a storage 74, and an eject button 101 which takes out the inserted storage 74 in a front side surface of the MCMP 1. Further, in the side surface on the opposite side, there exists a communication unit 103 comprising the communication module unit 20 of the MCMP 1. At an end of the communication unit 103, there are the wireless LAN antenna 21 and the mobile phone network antenna 22, and these antennas are extruded and exposed from the main body of the MCMP 1. The communication unit 103 can be detached from the main body of the MCMP 1, and, in that case, the main body of the MCMP 1 can function by itself. Although not shown, the main body of the MCMP 1 includes the speaker 71.

Next, referring to FIG. 1, a processing flow will be described in the case of synchronously reproducing sound data stored in a storage 74 and motion picture data distributed from the content provider 2 through the network.

First, the CM 11 of the communication control unit 10 controls the communication module unit 20 to connect with the content provider 2. Then, the CM 11 receives an instruction of purchasing motion picture data from a user through the touch panel display unit 60. Next, the ECM 13 of the communication control unit 10 purchases the motion picture data by electronic settlement with the content provider 2. After the electronic settlement, the content provider 2 distributes the purchased motion picture data to the MCMP 1 through the network 3. The CM 11 controls the communication module unit 20 to download the motion picture data, and accumulates the motion picture data in the motion picture buffer 31 of the buffer control unit 30. Further, receiving an instruction from the CM 11, the storage control unit 73 reads the sound data (corresponding to the purchased motion picture data) from the storage 74, and outputs the sound data to the sound buffer 32 through the data control unit 72.

Then, the CM 11 sends a motion picture data license key and a sound data license key stored in the LM 14 to the motion picture decryptor 41 and the sound decryptor 51, respectively.

In the motion picture reproducing unit 40, the motion picture decryptor 41 reads the motion picture data stored in the motion picture buffer 31, from the top of the data. Then, using the license key, the motion picture decryptor 41 decrypts the motion picture data encrypted by the copyright protection technique, and outputs the decrypted data to the motion picture decoder 42.

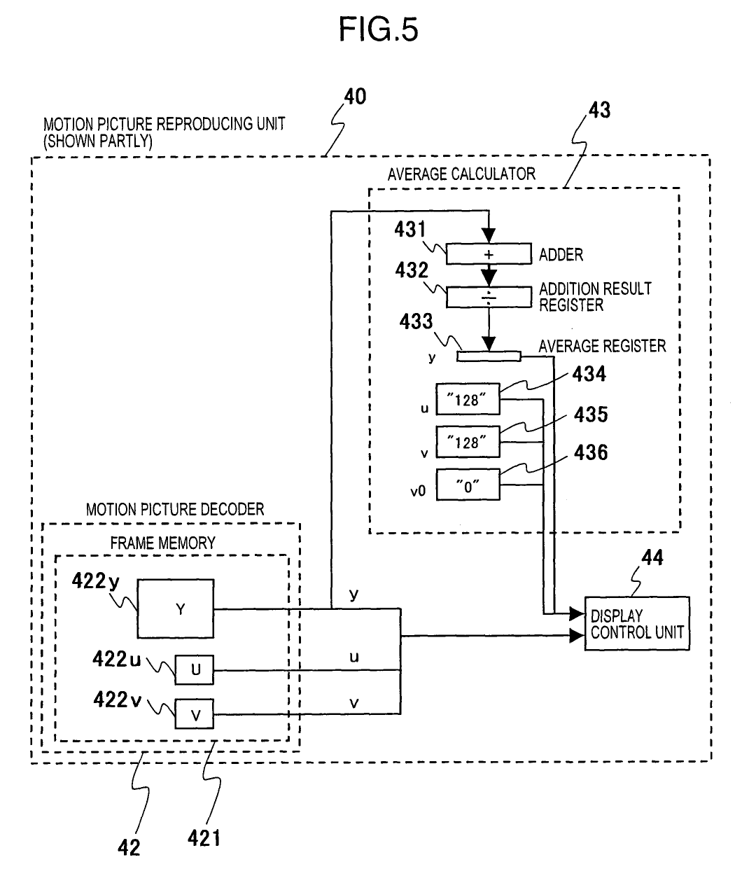

The motion picture decoder 42 expands (decodes) the compressed (encoded) motion picture data that are outputted from the motion picture decryptor. At that time, the motion picture decoder 42 expands the motion picture data into yuv format frames in a frame memory. According to the yuv format, a color is expressed by three pieces of information, i.e., a luminance signal (Y), a difference (U) between the luminance signal and a red component, and a difference (V) between the luminance signal and a blue component in a frame memory. Then, the display control unit 44 converts the yuv format frames expanded in the frame memory into the RGB format according to which a color is expressed as a combination of three colors, i.e., red (R), green (G) and blue (B), and outputs the converted data to the touch panel display unit 60. By the way, processing in the average calculator 43 will be described later, referring to FIG. 5.

In the sound reproducing unit 50, the sound decryptor 51 reads the sound data stored in the sound buffer 32, from the top of the data. Then, using the license key, the sound decryptor 51 decrypts the sound data encrypted by the copy protection technique, and outputs the decrypted data to the sound decoder 52. The sound decoder 52 expands (decodes) the compressed (encoded) sound data, and accumulates the expanded PCM (Pulse Code Modulation) format sound data in the PCM buffer 53. Then, the digital-analog converter 54 reads only the top of the PCM format sound data accumulated in the PCM buffer 53, and awaits timing of reproducing the sound data in a converted state from digital to analog. At a point of time when the capacity of the PCM buffer 53 is fully accumulated with the sound data, the sound decoder 52 temporarily stops decoding of the sound data.

In the present embodiment, when the processing time of the motion picture decoder 42 is compared with the processing time of the sound decoder 52, it is obvious that the processing time of the motion picture decoder 42 is longer. Accordingly, it is necessary that the top of the sound data and the first frame of the motion picture data are made coincident with each other in reproducing output timing (beginning). A method for that end is described in the following.

The motion picture decoder 42 decodes the first frame at the top of the motion picture data, and outputs the decoded data to the display control unit 44. At that time, the motion picture decoder 42 asserts (i.e., makes effective or activates) a synchronous reproducing start signal 421 to the digital-analog converter 54. Then, the display control unit 44 reads the decoded first frame of the motion picture data, converts the read data into an RGB format frame, and outputs the converted frame to the touch panel display unit 60. At the time of output to the touch panel display unit 60, the display control unit 44 asserts a synchronous reproducing start signal 441 to the digital-analog converter 54.

When the synchronous reproducing start signal 441 from the display control unit 44 is asserted in the state that the synchronous reproducing start signal 421 from the motion picture decoder 42 is asserted, then, the digital-analog converter 54 outputs the sound data (that have been already converted to analog) to the speaker 71. Thus, the output start timings of the sound data and the motion picture data can be made coincide with high precision.

Once reproducing is started, the sound data is outputted from the PCM buffer 53 to the digital-analog converter 54, and an empty space is produced in the PCM buffer 53. Then, the sound decoder 52 resumes the interrupted decoding of the sound data, and replenishes the PCM buffer 53 with the sound data. Accordingly, the sound data is reproduced to its end, while voice coming from the speaker 71 is not interrupted. In the interim, the motion picture decoder 42 performs decode processing of the motion picture data to the end of the motion picture data, and the display control unit 44 outputs the data in the frame memory to the touch panel display unit 60. However, as described above, the processing of the motion picture data is slower than the processing of the sound data, and there occurs discrepancy between the sound reproducing output and the motion picture reproducing output. Now, a method of synchronizing reproducing outputs of the sound data and the motion picture data will be described, in the course of reproducing of the sound data and the motion picture data.

First, at the time of asserting the above-mentioned synchronous reproducing start signals 421 and 441, the digital-analog converter 54 starts sending a sound synchronizing signal 541 to the motion picture decoder 42 and the display control unit 44. This sound synchronizing signal 541 is a reference signal for reproducing the sound data and the motion picture data synchronously, and sent to the motion picture decoder 42 at a clock rate according to a sampling rate (for example, 44.1 kHz) of the sound data reproduced by the digital-analog converter 54. The motion picture decoder 42 counts the sound synchronizing signal 541 to calculate time (for example, one second in the case of 44.1 kHz), so as to obtain a reference time. This time is the reproducing time (elapsed time) of voice.

Based on this reference time, the motion picture decoder 42 calculates a reproducing interval for one frame, which is expressed as the reciprocal of the frame rate of the motion picture data, and reproduces each frame sequentially at this interval. Here, sending of the sound synchronizing signal 541 is stopped, according to a sound stop instruction from the motion picture decoder 42. In detail, at the time of negating (i.e., making ineffective or inactivating) the synchronous reproducing start signal 421 sent from the motion picture decoder 42, the digital-analog converter 54 stops sending the sound synchronizing signal 541.

In the course of the synchronous reproducing, the motion picture decoder 42 measures the decode processing termination time for each frame of the motion picture data inputted sequentially. Further, the motion picture decoder 42 calculates an estimated reproducing time for each frame of the motion picture data inputted sequentially, by multiplying the number of frames counted from the start of decoding to the frame in question by the reproducing interval for one frame. When delays of decode processing of the motion picture decoder 42 accumulate and the decode processing termination time of a certain frame is past the estimated reproducing time of that frame, then, after decoding of that frame, the motion picture decoder 42 controls sending of that frame such that the frame is not sent to the display control unit 44 (namely, display is not updated, or the frame in question is skipped). The display control unit 44 continues to display the frame previous to the frame in question (in other words, the frame now on display continues to be displayed).

Thus, when decode processing of the motion picture data is delayed, a frame is not displayed to lower the frame rate and to synchronize the reproducing output of the motion picture data with the reproducing output of the sound data. Here, when reproducing is started once, the digital-analog converter 54 continues the reproducing processing as long as the synchronous reproducing start signal 421 is asserted. Thus, even when display is not updated by an intermediate frame that is skipped without being displayed, it is continued to reproduce the sound.

As described above, the digital-analog converter 54 informs the motion picture decoder 42 of the reference time since the start of reproducing of the sound data, by sending the sound synchronizing signal 541 to the motion picture decoder 42. Based on the reference time, the motion picture decoder 42 can thin out the frames and maintain the predetermined frame reproducing intervals to realize synchronous reproducing of the sound and the motion picture. Accordingly, it is possible to give an impression (lip-sync) that voice from a human figure on a screen is synchronized with motion of his lips. As a result, a viewer of the motion picture can listen and look the sound and the motion picture comfortably without a sense of incongruity.

Next, a case in which a user using the MCMP 1 stops reproducing in the course of reproducing of the motion picture, will be described. When a stop instruction from the user is received through the touch panel display unit 60 of the MCMP 1 in the course of reproducing of the motion picture, the motion picture decoder 42 stops the decoding processing at a point of time when decoding of a frame under processing is finished, and does not send the decoded frame data to the display control unit 44. Then, after a lapse of the above-calculated reproducing interval for one frame, the motion picture decoder 42 negates the synchronous reproducing start signal 421 to the digital-analog converter 54. Receiving this negation, the digital-analog converter 54 stops the reproducing output of the sound data. Further, when the display control unit 44 does not receive new frame data from the motion decoder 42 after a lapse of a predetermined time (for example, the above-calculated reproducing interval for one frame), then, the display control unit 44 negates the synchronous reproducing start signal 441, and maintains the output of the frame data now under output. As a result, the touch panel display unit 60 stops in a state of the presently-displayed image, and voice does not come from the speaker.

When a stop cancellation instruction from the user is received through the touch panel display unit 60 of the MCMP 1 in the state of stopping of the motion picture, then, the motion picture decoder 42 asserts the synchronous reproducing start signal 421 to the digital-analog converter 54, and sends the decoded frame to the display control unit 44. The display control unit 44 converts the sent frame into the RGB format to output to the touch panel display unit 60. At that time, the display control unit 44 asserts the synchronous reproducing start signal 441 to the digital-analog converter 54. When the digital-analog converter 54 receives the assertion of the synchronous reproducing start signal 441 in a state that the synchronous reproducing start signal 421 is asserted, then, the digital-analog converter 54 resumes the reproducing output of the sound data. Thus, in resuming the reproducing from the state that the reproducing is stopped after receiving a reproducing stop instruction in the course of reproducing of the motion picture, synchronous reproducing between the sound and the motion picture can be realized.

Next, will be described reproducing of sound data and motion picture data in a clipping mode and in a repeat mode, which are reproducing methods in which motion picture data are reproduced preferentially.

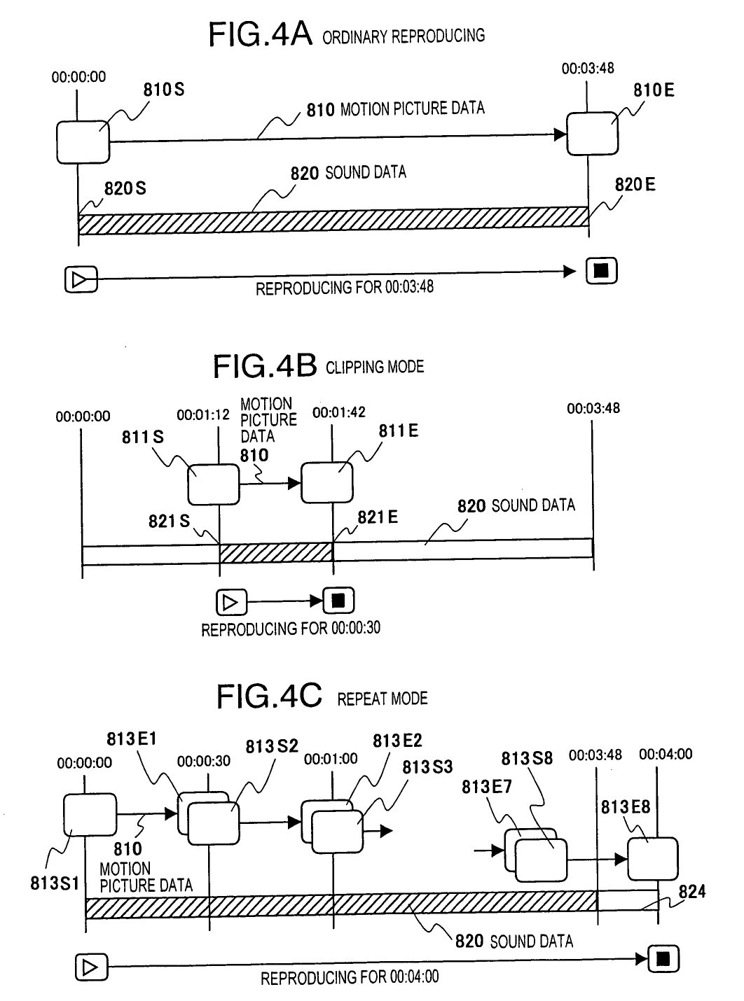

FIGS. 4A, 4B and 4C schematically show cases in which sound data and motion picture data are reproduced in the clipping mode and in the repeat mode.

In ordinary synchronous reproducing, as shown in FIG. 4A, motion picture data 810 are reproduced synchronously with sound data 820 according to a sound synchronizing signal 541 sent from the digital-analog converter 54, and the reproducing of the motion picture data 810 is ended at the same time with the sound data 820. In FIG. 4A, the reproducing time of the motion picture data 810 and the sound data 820 is 3 minutes and 48 seconds as an example. The reproducing of the motion picture data 810 and the sound data 820 starts at 00:00:00 (0 minute and 0 second) (810S, 820S), and ends at 00:03:48 (3 minutes and 48 seconds) (810E, 820E).

FIG. 4B is a schematic diagram showing reproducing in the clipping mode. For example, in the case of motion picture data used for advertisement, usually the motion picture data are edited to have short reproducing time of 15 sounds through 30 sounds. In the clipping mode, edited short time motion picture data 810 are reproduced, and sound data 820 are reproduced only partly for the same length as the reproducing time of the edited motion picture data 810. In FIG. 4B, according to the reproducing time (811S, 811E) of the motion picture data 810, the sound data 820 are reproduced and outputted for only 30 seconds from 00:01:12 (821S) to 00:01:42 (821E) out of the total reproducing time (3 minutes and 48 seconds).

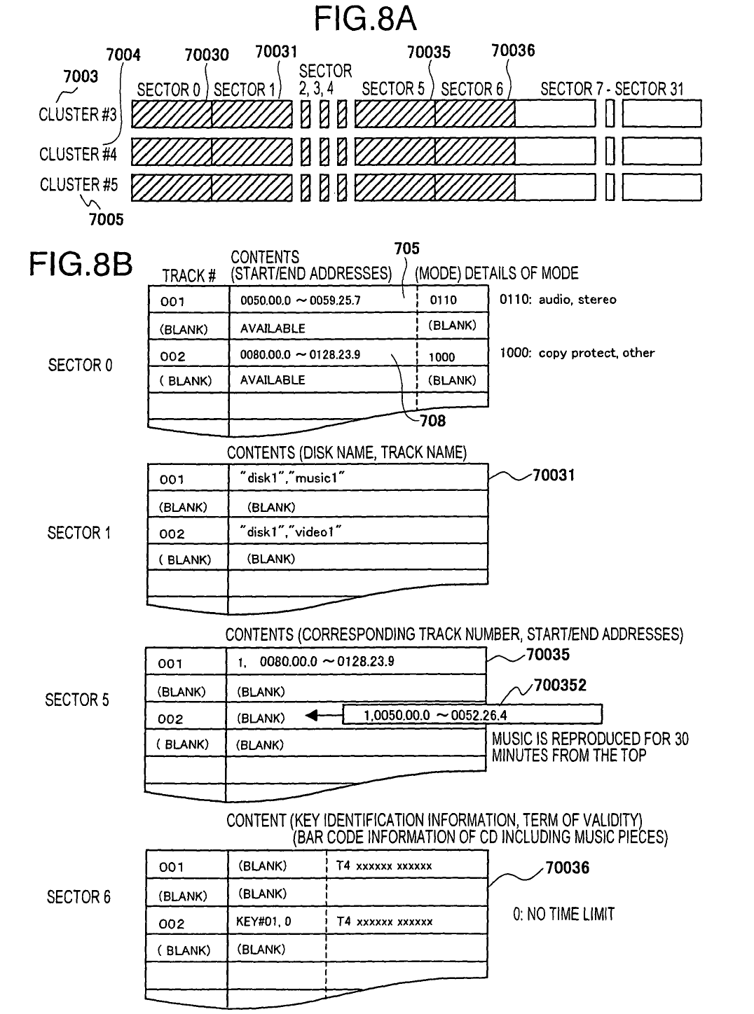

To realize the thus-described clipping mode, when motion picture data (a motion picture content) are downloaded from the content provider 2, reproducing information (a starting address and a reproducing ending address) of the corresponding sound data is received at the same time and stored together with the motion picture data onto the storage 74. Storing of the reproducing information will be described later referring to FIG. 8. Then, based on the reproducing information, the storage control unit 73 inputs the sound data from 00:01:12 into the sound buffer 32, and the sound reproducing unit 50 starts reproducing and output of the sound data synchronously with display (821S) of the top frame of the motion picture data. After 30 minutes, the sound reproducing unit 50 ends the reproducing of the sound data at the same time with display (821E) of the last frame of the motion picture data. According to reproducing of sound data in the clipping mode, it is possible to impress a viewer strongly with an impressive motion picture scene while reproducing a music phrase or melody line (called a highlight or a refrain) that can easily remain in the viewer's mind.

FIG. 4C is a schematic diagram showing reproducing in the repeat mode. In the repeat mode, motion picture data having shorter reproducing time than sound data are reproduced repeatedly. For example, it is assumed as shown in the figure that reproducing time of the motion picture data is 30 minutes at a time and reproducing time of the sound data is 3 minutes and 48 seconds. In this case, the motion picture data are reproduced from 00:00:00 (813S1) to 00:00:30 (313E1) for the first time, and from 00:00:31 (313S2) to 00:01:00 (813E) for the second time. Similarly, reproducing is repeated through the eighth time, and thus the motion picture data are reproduced for 4 minutes in total. On the other hand, the sound data 820 are reproduced for 3 minutes and 48 seconds. For the remaining time (22 seconds) of the total reproducing time (4 minutes) of the motion picture data, the sound data are reproduced for 22 seconds from the top of the sound data. Or, the remaining time may be kept silent (824). Similarly to the clipping mode, in the repeat mode reproducing, when motion picture data (a motion picture content) are downloaded from the content provider 2, reproducing information of the corresponding sound data is received at the same time and stored together with the motion picture data onto the storage 74. In the repeat mode, contents of motion picture data do not agree with contents of sound data, and the motion picture data are displayed repeatedly while music independent of the contents of the motion picture is played. Repeated display of motion picture data gives an impression of a revolving lantern to a viewer, and the motion picture can impress the viewer.

Motion picture data (a motion picture content) using the clipping mode or the repeat mode can be used for a preview of a movie, an advertisement of a teleplay or the like, or an advertisement such as a sales advertisement of a concert ticket by an event promoter. Otherwise, such motion picture data may be used as contents of a background video.

Next, will be described processing in the case where reproducing of motion picture data ends earlier than sound data, or reproducing of sound data ends earlier than motion picture data. For example, when, in the above-described repeat mode, the reproducing time of the sound data is longer than the total reproducing time of the motion picture data, contrary to FIG. 4C, then, a predetermined frame is displayed after the reproducing of the motion picture data ends, until the reproducing of the sound data ends. In the following, a method of generating the predetermined frame will be described, referring to FIG. 5.

FIG. 5 is a diagram showing detailed configurations of the motion picture decoder 42 and the average calculator 43 of the motion picture reproducing unit 40 shown in FIG. 1. As described above, the motion picture decoder 42 converts motion picture data into frame data of the yuv format in which a color is expressed by three pieces of information, i.e., a luminance signal (Y), a difference (U) between the luminance signal and a red component, and a difference (V) between the luminance signal and a blue component. The motion picture decoder 42 has frame memories (422y, 422u and 422v) respectively for the three pieces of information, y, u and v. The average calculator 43 includes a y value adder 431, a y value addition result register 432, a y value average register 433, a u value register 434 for storing a fixed value for a u value, a first v value register 435 for storing a fixed value for a first v value, and a second v value register 436 for storing a fixed value for a second v value.

With respect to the last frame of the motion picture data, the average calculator 43 reads a y value sequentially from the y value frame memory 422y of the motion picture decoder 42, and inputs the read y value into the adder 431. The adder 431 repeatedly performs addition processing of the y value inputted sequentially, and stores the addition result into the addition result register 432 at the end of the addition processing. Then, the average calculator 43 calculates an average of the y value based on the value of the addition result register 432, and stores the average of the y value into the average register 433.

In the case where the sound synchronizing signal 541 is sent from the digital-analog converter 54 even when frame output from the motion picture decoder 42 ends, the display control unit 44 reads the y value average stored in the y value average register 433, the fixed value “128” of the u value stored in the u value register 434, and the fixed value “128” of the v value stored in the first v value register 435. Then, the display control unit 44 outputs the frame based on the y value, u value and v value read above into the touch panel display unit 60, as long as the sound synchronizing signal 541 is sent from the digital-analog converter 54.

In the case where a color difference signal is expressed by 8 bits, the fixed value “128” of the u value and the first v value means the middle value (plus-minus zero). When the u value and the v value are “128”, the color becomes achromatic, and the display control unit 44 outputs a frame of white, gray or black according to the luminance of the y value stored in the y value average register 433 to the touch panel display unit 60.

Further, in the case where a color difference signal is expressed by 8 bits, the fixed value “0” of the second v value means a minus value having no blue component. Thus, when the display control unit 44 reads “0” stored in the second v value register 436 instead of the fixed value “128” stored in the first v value register 435, then, the display control unit 44 outputs a frame of sepia whose brightness varies dependent on the luminance of the y value average.

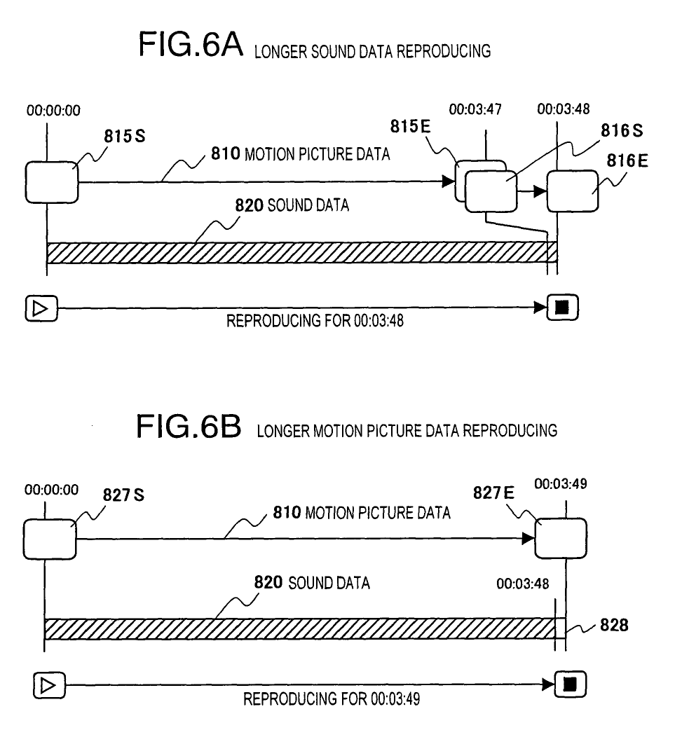

FIGS. 6A and 6B are diagrams schematically showing the case where the reproducing time of motion picture data is different from the reproducing time of sound data. The example shown in FIG. 6A is a case where the reproducing time of sound data 820 is longer than the reproducing time of motion picture data 810. It is assumed that the reproducing time of the sound data 820 is 3 minutes and 48 seconds (826) and the reproducing time of the motion picture data 810 extends from 00:00:00 (815S) through 00:03:47 (815E). In this case, the average calculator 43 calculates an average of the y value all over the last frame (815E) of the motion picture data. Then, the display control unit 44 reads the average of the y value, the fixed value of the v value and the fixed value of the u value from the respective registers 433, 434 and 435 of the average calculator 43, to paint over a frame with white, gray or black, and outputs this frame to the touch panel display unit 60. In the period extending from 00:03:47 (816S) through 00:03:48 (816E), the touch panel display unit 60 continues to display this frame.

The example shown in FIG. 6B is a case where the reproducing of motion picture data 810 is longer than the reproducing time of sound data 820. The reproducing time of the sound data is 3 minutes and 48 seconds (827) and the reproducing time of the motion picture data 810 extends from 00:00:00 (827S) through 00:03:49 (827E). After the reproducing of the sound data ends at 00:03:48, the reproducing of the motion picture data continues. It is assumed that, during that time (from 00:03:48 through 00:03:49), a silent state is kept, and the digital-analog converter 54 does not output the sound data to the speaker 71 (828).

Next, will be described a method of storing sound data and motion picture data onto a storage 74 and a method of managing the sound data and the motion picture data.

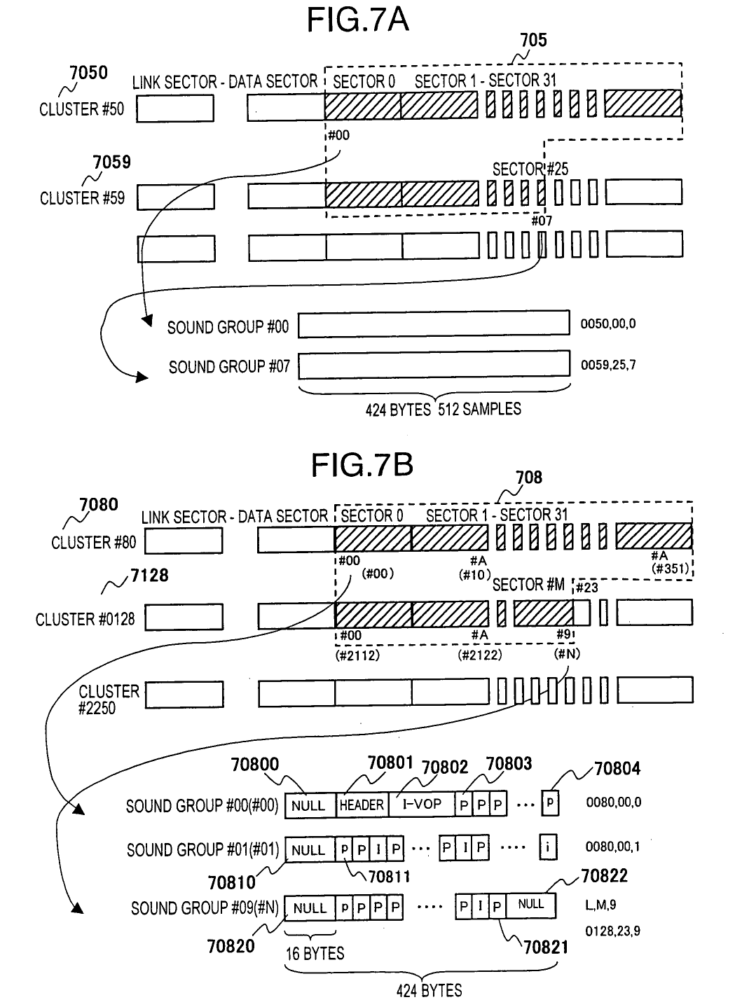

FIGS. 7A and 7B are diagrams showing a method of storing sound data and motion picture data in the case where an MD (mini disk) is used as a storage 74. Although not shown, sound data are stored as a track number 1 and motion picture data are stored as a track number 2 on an MD. Usually, a track number indicates a serial number of a music piece. In the present embodiment, data stored in an MD are managed by hierarchical structure of a cluster, a sector and a sound group of the MD. Thus, a storing address of MD data is expressed as “cluster.sector.sound group”. Here, one cluster includes 32 sectors, and two sectors include 11 sound groups.

FIG. 7A shows an example of a method of storing sound data. The reference numeral 705 refers to a sector group into which sound data of the track number 1 are written, 7050 to the 50th cluster, and 7059 to the 59th cluster. In the MD shown in FIG. 7A, the sound data are stored in the 50th cluster (7050) through the 59th cluster (7059). The sound data occupy the 0th sector of the 50th cluster (7050) through the 25th sector of the 59th cluster (7059). Further, the last sector (i.e., the 25th sector of the 59th cluster) is occupied by the 7th sound group at a maximum. Thus, the track 1 area occupied by the sound data is expressed by the address 0050.00.0 to the address 0059.25.7. Compression of the sound data is performed such that 512 samples are compressed into 424 bytes at a maximum and stored in one sound group.

FIG. 7B shows an example of a method of storing motion picture data. The reference numeral 708 refers to a sector group into which motion picture data of the track number 2 are written, 7080 to the 80th cluster, and 7128 to the 128th cluster. The motion picture data occupy the 0th sector of the 80th cluster (7080) through the 23rd sector of the 128th cluster (7128). Further, the last sector is occupied by the 9th sound group at a maximum. Thus, the occupied area is expressed by the address 0080.00.0 to the address 0128.23.9.

To store the motion picture data in sound groups each having the capacity of 424 bytes, the motion picture data are divided irrespective of the GOP (group of picture) unit of MPEG as a compression format of motion picture data, before the data are stored into sound groups. When the motion picture data are stored sequentially from the 0th sector of the 80th cluster (7080), then, the 0th sound group (#00) stores a certain amount of NULL data (70800) followed by a header (70801) of the m4v format as the video file format of MPEG4, IVOP (intra video object plane) (70802), and PVOP (predictive video object plane) (70803), in turn. At last, the 0th sound group stores PVOP (70804), which is a division of PVOP. Since the capacity occupied by the NULL data (70800) through the last PVOP (70804, 70811) exceeds 424 bytes, pVOP (70811) exceeding the 425th byte is split and stored in the 1st sound group (#01) following the leading NULL data (70810) of that sound group. Similarly, also in another sound group, the last IVOP or PVOP is divided at the 425th byte, and stored in two sound groups.

The motion picture data are stored up to the 9th sound group of the 23rd sector of the 128th cluster. This 9th sound group begins from the NULL data (70820) and ends with PVOP (70821). In the case where the capacity occupied by the NULL data (70820) through the last PVOP (70821) does not reach 424 bytes, then, the remaining area (70822) is embedded with NULL data or 0.

Insertion of a certain amount of NULL data can prevent a conventional MD player from erroneously reproducing motion picture data as sound data.

FIGS. 8A and 8B show methods of managing sound data and motion picture data. In the present embodiment, an MD is used as a storage 74.

FIG. 8A shows UTOC (User Table of Contents) that stores management information on tracks of the MD, and a user can rewrite UTOC.

In FIG. 8A, the reference numeral 7003 refers to the 3rd cluster, 7004 to the 4th cluster, and 7005 to the 5th cluster. Further, the reference numeral 70030 refers to the 0th sector of the 3rd cluster, 70031 to the 1st sector of the 3rd cluster, 70035 to the 5th sector of the 3rd cluster, and 70036 to the 6th sector of the 3rd cluster.

The UTOC is stored in the 3rd cluster (7003), and a duplicate of the UTOC having the same contents as the cluster 7003 is stored in each of the 4th and 5th clusters (7004 and 7005) as a backup to be used at the time of failure. In the present embodiment, the UTOC uses the 0th sector (70030) through the 6th sector (70036) of the 3rd cluster (7003).

FIG. 8B shows details of the sector 0, the sector 1, the sector 5, and the sector 6.

The 0th sector (70030) stores a track number, an occupied address, and a mode. The occupied address shows start and end addresses of the data stored in the track number in question. The mode indicates whether the data stored in the track number in question are sound data or not, and whether there is copy limitation or not. The first line stores sound data of the track number 001. In the case of the sound data shown in FIG. 7A, the track number stores “001”, the occupied address stores “0050.00.0, 0059.25.7”, and the mode stores “0110” (705). The mode “0110” means that the data are sound data and stereo. In the second line, the track number stores “BLANK”, and the occupied address stores “AVAILABLE”, and the mode stores “BLANK”, indicating an unused area until “002” appears in the track number.

The third line stores motion picture data of the track number 002. In the case of motion picture data shown in FIG. 7B, the track number stores “002”, the occupied address stores “0080.00.0, 0128.23.9”, and the mode stores “1000” (708). The mode “1000” means that copy is limited. Then, in the fourth line, the track number stores “BLANK”, the occupied address stores “AVAILABLE”, and the mode stores “BLANK”, indicating an unused area.

The 1st sector (70031) stores a disk name and a track name for each track. For the first track, “disk1” and “music1” are stored. And, for the second track, “disk1” and “video1” are stored.

In the present embodiment, the 5th sector (70035) (which is an unused area (undefined area) in an ordinary MD) stores reproducing information that associates the sound data and the motion picture data. This 5th sector (70035) stores a track number, the total number of corresponding tracks, and corresponding start and end addresses. In detail, first, “001” as the track number of sound data, “1” as the number of corresponding tracks, and “0080.00.0, 0128.23.9” as the start and end addresses of the motion picture data are stored (70035). Then, following “BLANK” indicating an unused area, “002” as the track number of the motion picture data and the information of the sound data corresponding to the motion picture data are stored. Since the association between the motion picture data of this track number “002” and the sound data has been already given in the information of the sound data of the track number “001”, the information on the corresponding sound data becomes “BLANK” in the case of ordinary reproducing in which the reproducing time of the sound data and the reproducing time of the motion picture data coincide. However, in the case where the motion picture data are reproduced in the clipping mode or the repeat mode, the number of corresponding tracks of the sound data and the addresses of the reproducing start position and end position (“1”, “0050.00.0, 0052.26.4”) are stored as the information on the corresponding sound data (700352).

Further, in the present embodiment, the 6th sector (70036) (which is an unused sector (undefined sector) in a conventional MD) stores license information. This 6th sector (70036) stores a track number, license key identification information, a term of validity, and bar code information of the CD including music pieces. The license key identification information is information required for specifying a license key stored in LM 14 of TRM 12. The sound data of the track number “001” shown in the figure are sound data checked out from a personal computer, exemplifying sound data that do not require license at the time of reproducing. Here, “checked out” means that data in a personal computer are transferred to an external device (the MCMP 1 in the present case) connected to the personal computer. Thus, the license key identification information and the term of validity become “BLANK”. Following this “BLANK”, the CD's bar code information “T4 xxxxxx xxxxxx” is stored. Further, with respect to the motion picture data of the track number “002” shown in the figure, “KEY#01” as the license key identification information and “0” as the term of validity are stored after the track number. Following them, the bar code information “T4 xxxxxx xxxxxx” of the same CD as the track number “001” is stored. The term of validity “0” means that there is no term of validity and the motion picture data can be reproduced without time limit. Further, when the bar code information of the CD of the sound data is stored in the information on the motion picture data of the track number “002”, the bar code information of the CD can be used for searching for the corresponding music content, even after the information of the sound data of the track number “001” is deleted. By the way, the license key of the track number “002” is not stored in the MD, but stored in LM 14 in TRM 12 described next. The track management information of the MD, described above referring to FIG. 8, is obtained together with the sound data or the motion picture data at the time of storing the sound data or the motion picture data onto the storage 74, and also the track management information is stored onto the storage 74.

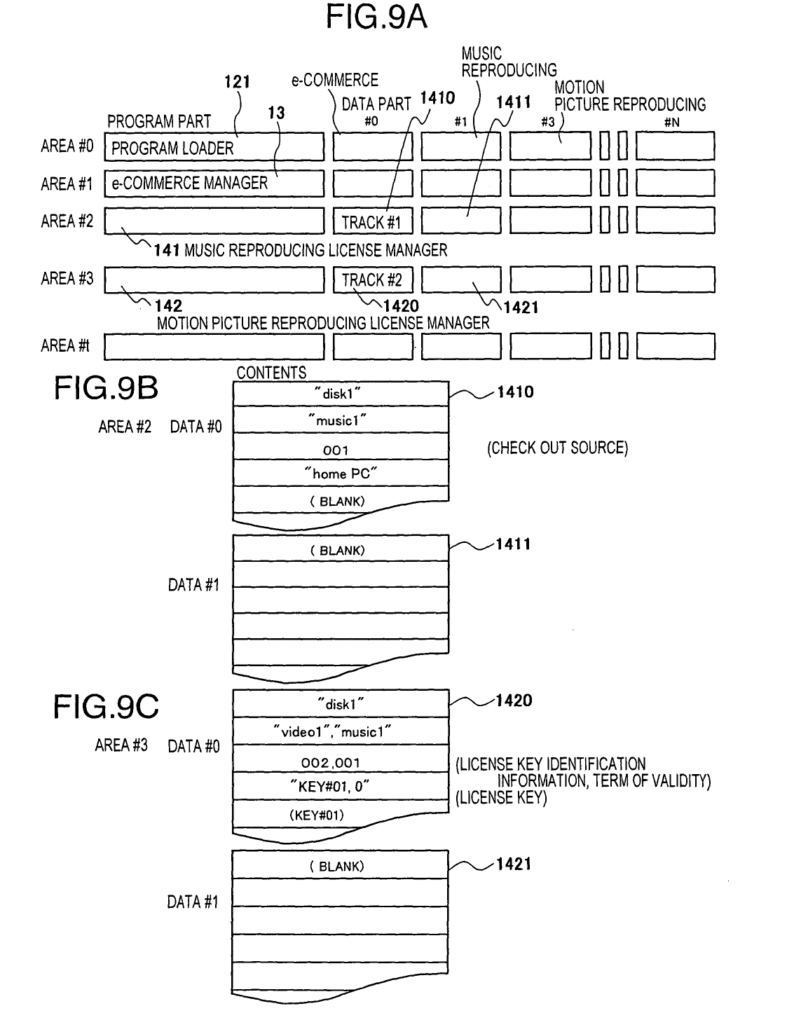

Next, will be described management of license information in TRM 12, referring to FIG. 9.

FIG. 9A is a diagram showing an example of storing structure for storing data of the TRM 12. The TRM 12 has a plurality of areas each having a program part and a data part. The program parts of the TRM 12 includes a program loader 121 in the 0th area, the ECM 13 in the 1st area, a music reproducing LM 141 in the 2nd area, and a motion picture reproducing LM 142 in the 3rd area. The program loader 121 in the 0th area judges correctness of each program, and stores the above-mentioned programs into the 1st and following program areas, respectively. The music reproducing LM 141 is downloaded from the content provider 2 or a site designated by the content provider, when a music content as sound data is purchased from the content provider 2. Then, the program loader 121 stores the downloaded music reproducing LM 141 into the program part of the TRM 12. Similarly to the music reproducing LM 141, also the motion picture reproducing LM 142 is downloaded from the content provider 2 or the like when a motion picture content as motion picture data is purchased, and then, stored into the program part of the TRM 12.

In the data part of the program loader 121 (the area #0), names (the ECM, the music reproducing LM, and the motion picture reproducing LM) of the programs stored in the program parts of the 1st and following areas are recorded in turn. Further, the 1st data part (1410) of the music reproducing LM (the area #2) stores license information of the sound data stored in the track 1, and the 1st data part (1420) of the motion picture reproducing LM (the area #3) stores license information of the motion picture data stored in the track 2. Next, these pieces of license information will be described referring to FIGS. 9B and 9C.

FIG. 9B is a diagram showing an example of the data part of the music reproducing LM 141 in the 2nd area. The 0th area (1410) of the data part stores the license information of the track 1, i.e., the sound data. The license information stores: a disk name; a track name; a track number; license key identification information and term of validity, or check out source information; and a license key itself. In detail, the disk name (“disk1”), the track name (“music1”), the track number (“001”), and the check out source (“homePC”) are stored in this turn. The sound data shown in the figure are sound data checked out from a personal computer, and thus, the check out source information is stored instead of the license key information. The first area (1411) of the data part does not store data, and becomes “BLANK”.

FIG. 9C is a diagram showing an example of the data part of the motion picture reproducing LM 142 in the 3rd area. The 0th area (1420) of the data part stores the license information of the track 2, i.e., the motion picture data. In detail, a disk name (“music1”, “disk1”), a track name (“video1”), a track number (“001”, “002”), license key identification information and term of validity (“Key#1, 0”) and a license key (“Key”) are stored in this turn. As described above, the term of validity “0” means that the motion picture data can be reproduced without time limit. By the way, the 1st area (1421) of the data part does not store data, and becomes “BLANK”.

According to the above-described method of storing sound data and motion picture data, it is possible to manage separately obtained sound data and motion picture data in one storage 73 (MD).

Next, will be described search, purchase, download and reproducing of sound data as a music content and motion picture data as a motion picture content, referring to FIGS. 10, 11 and 1.

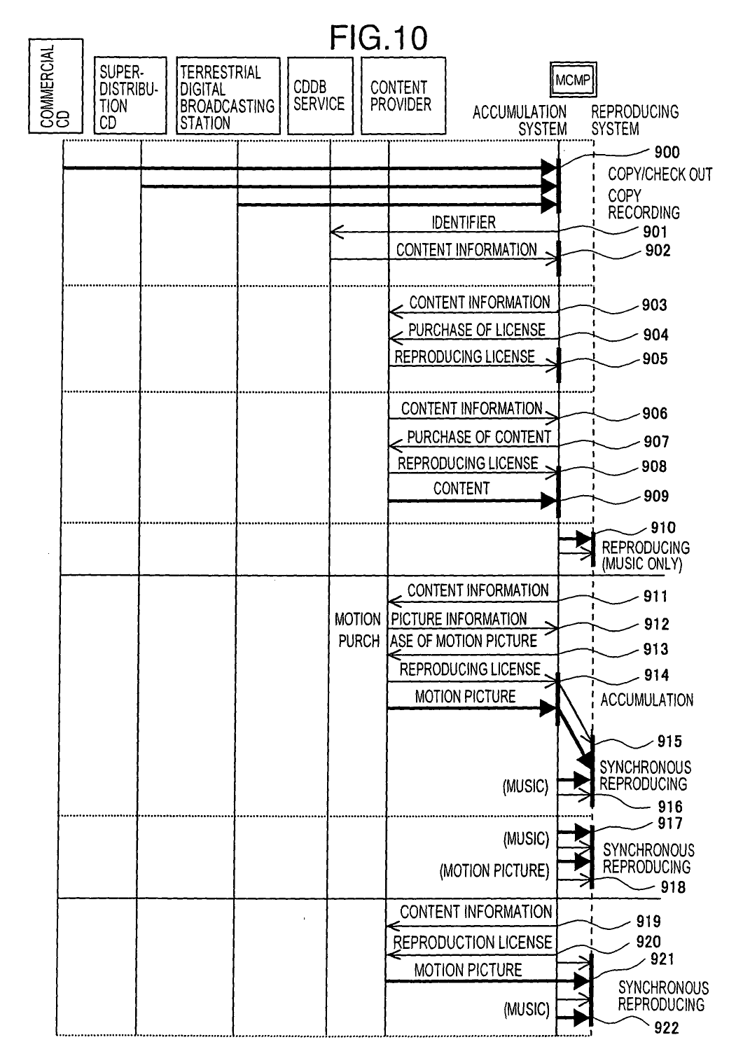

FIG. 10 is a diagram showing a flow of purchasing a music content and a motion picture content. In the present embodiment, first, a music content is obtained through the various paths described in the following, and sound data of this music content are stored onto a storage 74. As an obtaining path for a music content, two methods can be considered.

As a first method (900 to 905), may be considered: a method in which sound data stored in a music CD on the market are compressed on a personal computer, and checked out or downloaded from that personal computer; a method in which a music piece selling on Internet is downloaded; a method in which sound data are copied from a medium distributed free of charge such as a superdistribution CD; or a method in which sound data are recorded from a terrestrial digital broadcasting station. A superdistribution CD is a CD whose encrypted sound data (an encrypted content) are distributed separately from a key (a license key) for decrypting the encrypted sound data, permitting free distribution and copying of the encrypted content while protecting the license key by an encryption method different from the content's encryption method such that the content can not be copied by a device other than the authenticated device.

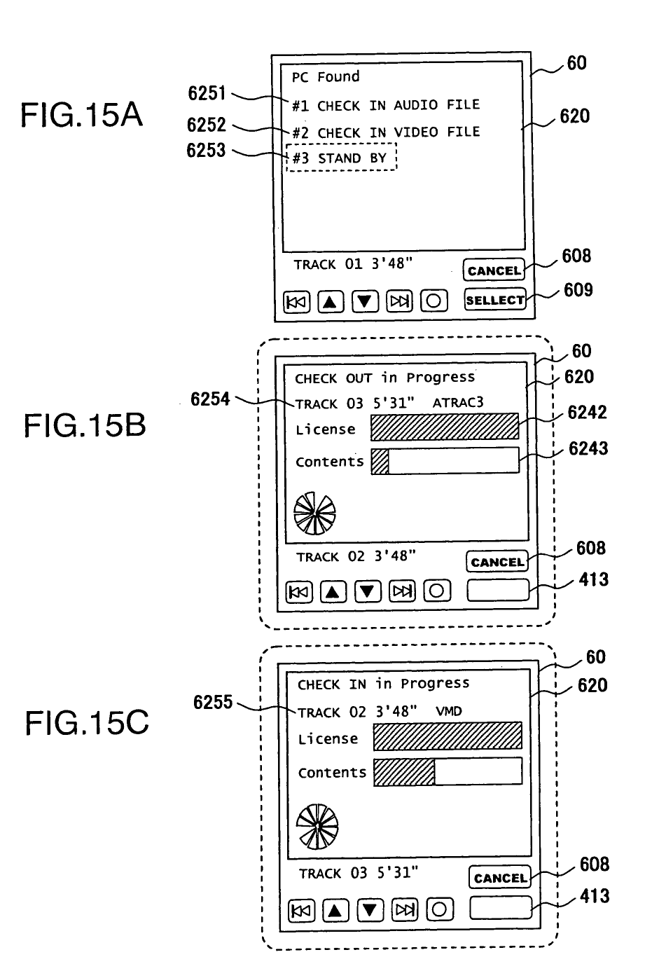

To obtain such a music content, the CM 11 receives an instruction from the user through the touch panel display unit 60 and controls the communication module unit 20 (the wireless LAN communication module 23 or the mobile phone network module 24) to download the sound data of the music content from an external system through Internet, for example. In the case of a music content recorded on a CD on the market or a superdistribution CD, the sound data of the music content are downloaded from a personal computer through an interface (such as NIC (Network Interface Card), for example) for connecting with the personal computer. That interface is included in the communication module unit 20 although not shown in FIG. 1. Interface (screen display on the touch panel display unit 60) at the time of connection with a personal computer will be described below referring to FIGS. 15A, 15B and 15C.

Then, the CM 11 stores the sound data obtained through the communication module unit 20 onto a storage 74 through the buffer control unit 30 (900). Further, in storing the sound data onto the storage 74, the CM 11 searches a database (for example, CDDB service on Internet) through the communication module unit 20, using an identifier such as, for example, a title of a music piece or information embedded in the sound data (901) to obtain information on the sound data such as a CD number, a title of a music piece, a copyright holder, a provider name, and the like (902). These pieces of information on the sound data are content identification information (hereinafter, referred to as content information) for identifying the content.

In the case where sound data having reproducing limitation such as sound data of a superdistribution CD are stored on a storage 74, it is necessary to purchase a license key to reproduce the sound data. In that case, the CM 11 receives an instruction from the user through the touch panel display unit 60, sends the above-mentioned content information to the content provider through the communication module unit 20 (903), and sends an instruction to purchase the license key to the content provider (904). Then, the communication module unit 20 downloads the license key from the content provider (905), to deliver it to the CM 11. The CM 11 delivers the license key to the LM 14 of the TRM 12, and the LM 14 stores the license key into the data part of the LM 14. The LM 14 downloads thus-stored license key to the sound decryptor 51 at the time of reproducing the sound data. The sound decryptor 51 uses this license key to decode the sound data, and thus, the sound data can be reproduced.

A second method (906 to 909) is one in which a content is purchased from the content provider 2 through sound distribution. Receiving an instruction from the user through the touch panel display unit 60, the CM 11 controls the communication module unit 20 to connect with the content provider 2 through the network 3, and obtains content information from the content provider 2 (906). Then, the CM 11 displays the obtained content information on the touch panel display unit 60, to receive an instruction of purchasing a music content selected by the user. Receiving the purchase instruction, the CM 11 sends a purchase instruction of the selected music content to the content provider 2 through the communication module unit 20 (907).

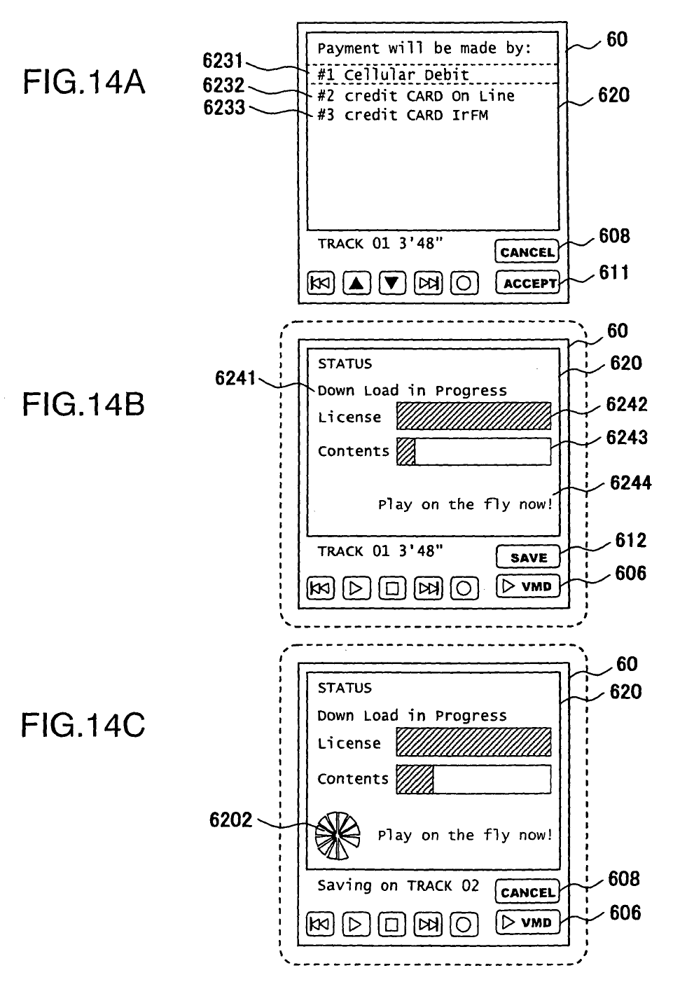

Next, the ECM 13 performs electronic settlement on the music content through the network. Although various methods of settlement exist, a method using a credit card is generally used. Interface (screen display on the touch panel display unit 60) at the time of performing electronic settlement will be described below referring to FIGS. 14A, 14B and 14C. When the ECM 13 completes the electronic settlement, the CM 11 downloads the license key from the content provider 2 through the communication module unit 20 (908). Similarly to the processing of the superdistribution CD (905), the CM 11 delivers the license key to the LM 14 of the TRM 12, and the LM 14 stores the license key into the data part of the LM 14. Next, the communication module unit 20 downloads the music content (sound data) purchased from the content provider 2. Then, the CM 11 stores the downloaded sound data onto the storage 74 (909).

Receiving an instruction from the user through the touch panel display unit 60, the CM 11 reads the sound data (obtained by the above-described first or second method) and the license key from the storage 74 and the LM 14, respectively, and inputs them into the sound reproducing unit 50. As a result, the purchased sound data can be reproduced (910). When the sound data are reproduced after storing the sound data onto the storage 74, it is not necessary to communicate with the content provider 2, and, the CM 11 can cancel the network connection with the content provider 2. Further, reproducing of the sound data is not limited to independent reproducing after once storing onto the storage 74 as described above. It is possible that the sound data are reproduced in the course of download from the content provider 2, or in the course of storing onto the storage 74 after the download (on-the-fly reproducing).

After obtaining the sound data and license key by the above-described first method (901 to 905) or second method (906 to 909), the motion picture data corresponding to the sound data are obtained.

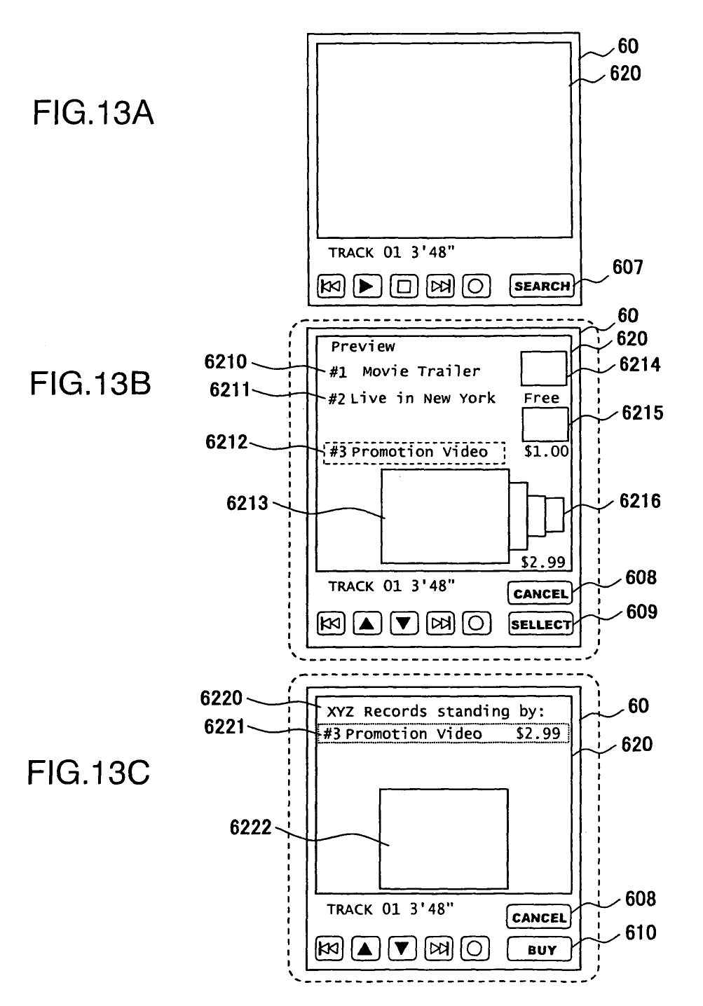

Receiving an instruction from the user through the touch panel display unit 60, the CM 11 connects with the content provider 2 through the communication module unit 20. Then, the CM 11 sends the music content information (obtained in 902 or 906) of the sound data to the content provider 2 (911). Next, the CM 11 obtains information on the motion picture content corresponding to the sent music content information from the content provider 2 through the communication module unit 20 (912). Then, the CM 11 displays the obtained motion picture content information on the touch panel display unit 60, to receive an instruction to purchase a motion picture content selected by the user. Receiving the purchase instruction, the CM 11 sends an instruction to purchase the selected motion picture content to the content provider 2 through the communication module unit 20 (913). Thereafter, similarly to the purchase of the music content (908, 909), the motion picture data and the license key of the motion picture data are downloaded (913, 914). Then, the CM 11 stores the license key of the motion picture data into the LM 14 of the TRM 12, and stores the motion picture data onto the storage 74. Interface (screen display on the touch panel display unit 60) at the time of purchasing the motion picture content will be described below referring to FIG. 13.

Further, the CM 11 can inputs the motion picture data into the motion picture reproducing unit 40 in the course of downloading the motion picture data, to perform on-the-fly reproducing using the already-stored license key (915). In the on-the-fly reproducing, the CM 11 can simultaneously reproduce the sound data already stored in the storage 74, not only the motion picture data in the course of downloading (916).

Thus, the sound data and the motion picture data corresponding to the sound data are stored on the storage 74, and thereafter reproducing of the music and the motion picture data can be enjoyed without connecting with the network 3. Receiving an instruction from the user through the touch panel display unit 60, the CM 11 reads the sound data and the motion picture data from the storage 74 and the sound license key and the motion picture license key from the LM 14 to input into the sound reproducing unit 50 and the motion picture reproducing unit 40 respectively, and reproduces the sound data and the motion picture data simultaneously. The method of the simultaneous reproducing is as described above. Namely, the motion picture decoder 42 and the display control unit 44 of the motion picture reproducing unit 40 send the synchronous reproducing start signals 421 and 441 to the digital-analog converter 54, to start reproducing making the reproducing output timing of the motion picture data coincide with the reproducing output timing of the sound data. In the course of reproducing, the digital-analog converter 54 sends the sound synchronizing signal 541 to the motion picture decoder 42 to synchronize the motion picture data with the sound data.

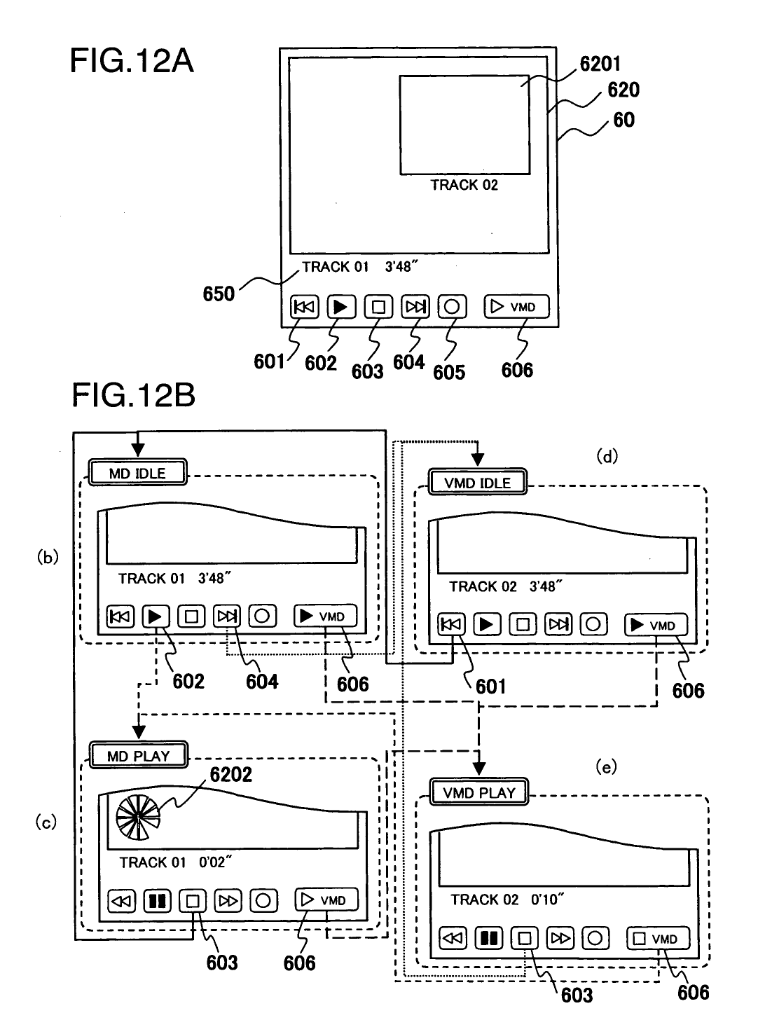

Here, it is possible to reproduce the sound data only by themselves in a state that the sound data and the corresponding motion picture data are stored in the storage 74. In that case, the CM 11 receives an instruction to reproduce the sound data only through the touch panel display unit 60, and sends a control signal to the storage control unit 73 not to read the motion picture data from the storage 74. Since the motion picture data are not reproduced, power consumption can be reduced in the storage control unit 73, the motion picture reproducing unit 40, the touch panel display unit 40, and the like, thus lengthening a battery life. Interface (screen display on the touch panel display unit 60) at the time of reproducing the sound data and the motion picture data will be described below referring to FIGS. 12A and 12B.

Now, there will be described the case where the motion picture content is purchased in 911 to 914 but not stored onto the storage 74, and the motion picture data are downloaded from the content provider 2 once again (919 to 922). As the case where the motion picture data are not stored onto the storage 74, may be considered a case where storing of the motion picture data fails owing to deficiency of the storage capacity of the storage 74, for example, or a case where it is intentional not to store the motion picture data onto the storage 74.

The CM 11 connects with the content provider 2 through the communication module unit 20, and sends the music content information to the content provider 2 again (919). Next, the CM 11 reads the motion picture license key from the LM 14, sends the read license key to the content provider 2 through the communication module unit 20 (920). The content provider 2 authenticates the received content information and motion picture license key, and sends the motion picture content to the MCMP 1 again. The CM 11 downloads the motion picture data through the communication module unit 20, and stores the data onto the storage 74 (921). In the course of this second downloading, it is possible to perform on-the-fly reproducing the sound data and the motion picture data synchronously (921, 922). In the case where the motion picture data can be downloaded from the content provider 2 any number of times as long as the license key of the motion picture is purchased once, it is not necessary to store the motion picture data onto the storage 74, and the storage capacity of the storage 74 can be reduced and the storage 74 can be used efficiently.

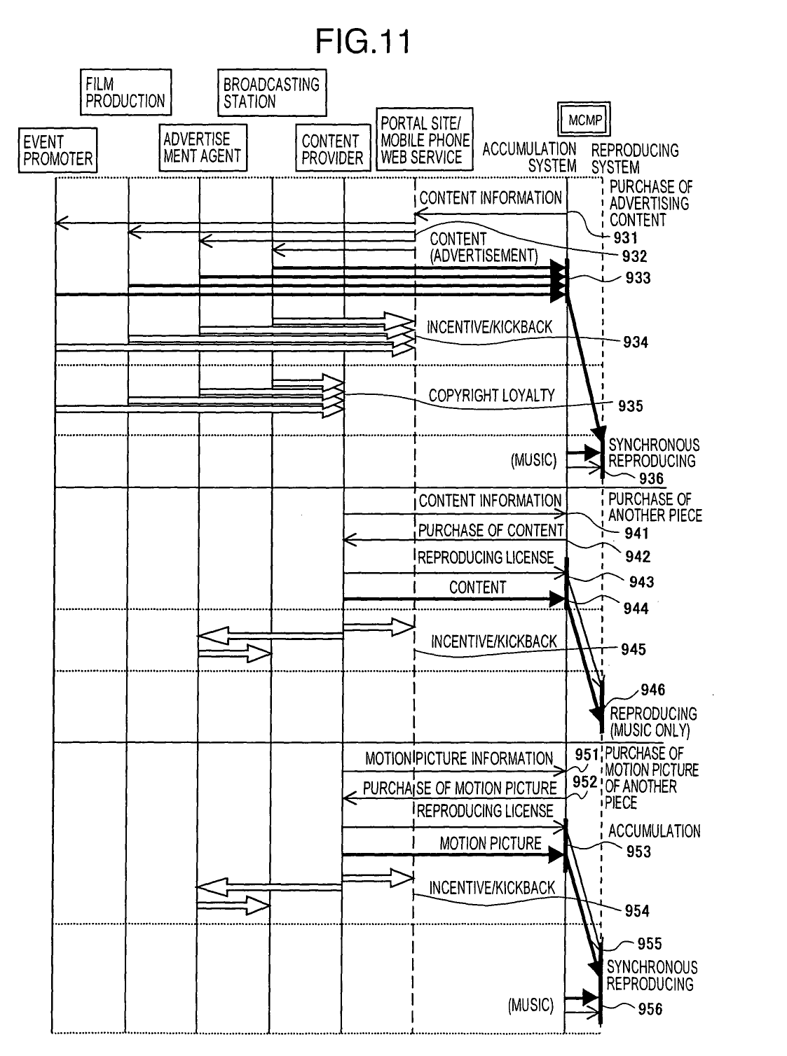

Next, referring to FIG. 11, will be described a processing flow of searching for the motion picture data more widely than FIG. 10. It is assumed that, at the time of searching for the motion picture data, the storage 73 stores at least the sound data and the sound data content information, and the LM 14 stores the sound license key. Here, it does not matter that, owing to the motion picture download shown in FIG. 10 (911 to 914, 919 to 921), the motion picture data and the motion picture license key have been already stored on the storage 74 and in the LM 14.

First, referring to FIG. 11, will be described a processing flow of searching for an advertising motion picture content. It is assumed that this advertising motion picture content does not require a license key and is free of charge. Receiving an instruction from the user through the touch panel display unit 60, the CM sends music content information to a portal site that searches for an advertising motion picture content, through the communication module unit 20 (931). As this portal site, may be considered a service for a mobile phone or a Web service on Internet. The portal site receives the content information and inquires of event promoters, film productions, advertisement agents, broadcasting stations, content providers, and the like as to existence of a motion picture content relating to the received content information 104 (932). In response to the inquiry of the portal site, the event promoters, the film productions, the advertisement agents, the broadcasting stations, the contents provider, and the like send information on motion picture contents to the MCMP 1 through the portal site (933). The CM 11 displays the motion picture content information received through the communication module unit 20 on the touch panel display unit 60. Then, the CM 11 receives a user's selection instruction inputted to the touch panel display unit 60, and sends information on the selected motion picture content to the portal site. Receiving the sent information, the portal site sends the selected motion picture content to the MCMP 1. As a result, the motion picture data of the selected motion picture content are downloaded to the MCMP 1 (933). Here, the motion picture data may be downloaded unconditionally without a user's instruction of selection.

When the download is ended, the portal site receives an incentive (a reward) or a kickback as an introducing fee from the event promoter, the film production, the advertisement agent, or the like (934). Further, in the case where the motion picture data are an advertising content, the sound data are reproduced as an insert of the advertising motion picture data when the motion picture data are reproduced in the MCMP 1, requiring payment of a copyright royalty for the sound data. The event promoter, the film production, the advertisement agent, the broadcasting station or the like pays the copyright royalty to the content provider 2 or the copyright holder (935). Then, the CM 11 receives a user's reproducing instruction inputted to the touch panel display unit 60, and synchronously reproduces the downloaded motion picture data and the sound data already stored on the storage 74 (936).

Next, will be described the case where the content provider 2 itself distributes content information on sound data to the MCMP 1 (941 to 946). The content provider 2 distributes music content information suiting a user's purchasing tendency of music contents to the MCMP 1 directly or through a portal site. For example, based on historical information of accessing from the MCMP 1 to the content provider 2 such as the above-described search for a motion picture content (931) or purchase of a music content (903 to 909 in FIG. 10), the content provider 2 distributes suitable content information to each MCMP 1 (941). Processing for purchasing a music content indicated in the distributed music content information is similar to the processing shown in FIG. 10 (906 to 909) for purchasing a music content from the content provider (941 to 944). Then, the sound data and the license key are stored onto the storage 74 and in the LM 14, and the sound data can be reproduced (946).

In the case where the MCMP 1 purchases the music content through the above-mentioned portal site, the content provider 2 pays the introducing fee to the portal site. Further, the above-mentioned payment (935) of the copyright royalty by an event promoter, or the like occurs since the event promoter or the like uses the music content independently of the content provider 2. In the present processing, the content provider 2 sells another music content successively. Thus, the content provider 2 pays an incentive or a kickback to an advertisement agent and a broadcasting station through the advertisement agent at the time when the purchase of the above-mentioned another music content is effected, based on history of payment and reception of incentives (934) and copyright royalties (935) (945).

When a music content distributed from the content provider 2 is purchased, then, the motion picture content information corresponding to the purchased music content is sent from the content provider 2 to the MCMP 1 directly or through the portal site (951). The motion picture content information may be sent when the CM 11 receives a requesting instruction inputted by the user to the touch panel display unit 60, and requests the content provider 2 to send the information. Or, the content provider itself may send the information to the MCMP 1. Processing for purchasing a motion picture content indicated in the sent motion picture content information is similar to the processing shown in FIG. 10 (913 to 915) for purchasing a motion picture content (952, 953, 955). Then, the motion picture data and the license key are stored onto the storage 74 and in the LM 14, and the motion picture data can be reproduced synchronously with the sound data already purchased (955, 956). At the time when the purchase of the content of the motion picture data is effected, the content provider 2 pays the introducing fee to the portal site similarly to 945, and pays an incentive or a kickback as an introducing fee to the advertisement agent and the broadcasting station through the advertisement agent (954).

In the search for motion picture data (a motion picture content) in a wider range as shown in FIG. 11, the content provider 2 may install street cameras in streets or picturesque places, and distribute motion picture data of images taken by those street cameras to the MCMP 1. For example, the CM 11 sends the content provider 2 sound data content information including the reproducing time of the sound data and a selection instruction for selecting motion picture data of a street or motion picture data of a picturesque place, through the network and the portal site. Receiving the information, the content provider 2 sends the motion picture data of the street or the picturesque place to the MCMP 1 for the period of the reproducing time of the sound data.

As described above, the music content and the motion picture content are searched for separately, and stored onto the storage 74.

Next, screens (user interfaces) displayed on the touch panel display unit 60 will be described referring to FIGS. 12 to 15 as examples. Here, the CM 11 controls a display screen according to a content of operation inputted to the touch panel display unit 60.

FIGS. 12A and 12B show examples of display screens in the case where sound data or motion picture data stored on the storage 74 are reproduced. FIG. 12A shows an idle state (MD IDLE) when power is turned on. As shown in the figure, the touch panel display unit 60 includes: a context display area 620 having a preview area 6201; a track information display area 650; and operating buttons on a touch panel. As the operating buttons, the touch panel display unit 60 has a previous track button 601, a reproducing button 602, a stop button 603, a next track button 604, a recording button 605, and a motion picture reproducing button 606. In the example shown in FIG. 12A, the track information display area 650 displays “TRACK 01 3'48”, showing that the reproducing time of the sound data of the track 1 is 3 minutes and 48 seconds.

FIG. 12B(b) shows the same power-on idle state (“MD IDLE”) as FIG. 12A. In this state, when the CM 11 receives push-down of the reproducing button 602, the screen transfers to a screen of a music reproducing state (“MD PLAY”) shown in FIG. 12B(c). Further, in this state, when the CM 11 receives push-down of the next track button 604, then, the screen transfers to a screen of a motion picture reproducing waiting state (“VMD IDLE”) shown in FIG. 12B(d). Further, in this state, when the CM 11 receives push-down of the motion picture reproducing button 606, then, the screen transfers to a screen of a motion picture reproducing state (“VMD PLAY”) shown in FIG. 12B(e).

In the music reproducing state (FIG. 12B(c)), a rotation state indicator 6202 (which shows that music reproducing is in progress) is displayed in the context display area 620. Further, in this state, when the CM 11 receives push-down of the stop button 603, then the state transfers to the power-on idle state (FIG. 12B(b). Or, when the CM 11 receives push-down of the motion picture reproducing button 606, then, the state transfers to the motion picture reproducing state (FIG. 12B(e)).

In the motion picture reproducing waiting state (FIG. 12B(d)), when the CM 11 receives push-down of the motion picture reproducing button 606, then, the screen transfers to the screen of the motion picture reproducing state (“VMD PLAY”) shown in FIG. 12B(e). Further, in this state, when the CM 11 receives push-down of the previous track button 601, then the screen transfers to the screen of the idle state (FIG. 12B(b)).

In the motion picture reproducing state (FIG. 12B(e)), the rotation state indicator 6202 disappears, and a motion picture is displayed in the context display area 620. In this state, when the CM 11 receives push-down of the stop button 603, then, the state transfers to the motion picture reproducing waiting state (FIG. 12B(d)). Or, when the CM 11 receives push-down of the motion picture reproducing button 606, then, reproducing of the motion picture is ended and the state transfers to the music reproducing state (FIG. 12B(c)).

As described above, it is possible to quickly switch reproducing track-wise in a state where an MD as the storage 74 stores sound data and motion picture data in different tracks from each other. Further, it is possible to seamlessly switch single reproducing of sound data and simultaneous reproducing of the sound data and motion picture data.

FIGS. 13A, 13B and 13C show examples of display screens in the case where motion picture data are searched for through the network. A display screen shown in FIG. 13A is displayed at a point of time when the CM 11 receives an instruction inputted through the remote control 77 to switch to a search mode and the communication module unit 20 connects with the content provider 2, being switched from a display screen of FIGS. 12A and 12B of the reproducing state. A mode switching instruction may be received through an external switch (not shown) provided on the main body of the MCMP 1.

FIG. 13A shows a state just after switching to the search mode. The display screen shown in FIG. 13A is different from the display screen shown in FIG. 12A of the reproducing state in that the context display area 620 does not have the preview area 6201, and a search button 607 for starting search for motion picture data is displayed instead of the motion picture reproducing button 606.

FIG. 13B displays a search result that is obtained when the CM 11 receives push-down of the search button 607 and makes a request to the content provider 2 for a motion picture content corresponding to the sound data of the track 1. As shown in the figure, for each motion picture content searched, the context display area 620 displays a title (6210, 6211, 6212), a thumbnail display area (6214, 6215, 6216) for showing a thumbnail, i.e., a reduced image for displaying a plurality of images at a glance, and a charge. Further, the context display area 620 displays a preview area (6213). In the preview area, a thumbnail to which a cursor is moved is displayed in an enlarged view. In FIG. 12B(b), the cursor is moved to the third motion picture content (6212). As operating buttons on the touch panel, a cancellation button 608 and a selection button 609 are displayed as well as the other buttons that are same as FIGS. 12A and 12B. When push-down of the selection button 609 is received in the state that the cursor is moved to the third content 6212, then the screen transfers to FIG. 13C.

FIG. 13C is a screen for the user to confirm purchase of the selected motion picture content. As shown in the figure, the context area 620 displays a seller's name 6220 of the selected motion picture content, the title and charge 6221 of the motion picture content, and the preview area 6222 showing the thumbnail. As operating buttons on the touch panel, the cancellation button 608 and a purchase button 610 are displayed as well as the other buttons that are same as FIGS. 12A and 12B. When the user's intent to purchase is confirmed and push-down of the purchase button 610 is received in this screen, then, the screen transfers to a content purchase screen shown in FIGS. 14A, 14B and 14C.

FIGS. 14A, 14B and 14C show examples of a display screen at the time of purchasing a content. FIG. 14A shows a screen displayed after push-down of the purchase button shown in FIG. 13C. As shown in the figure, the context display area 620 of the touch panel display unit 60 displays various payment means (6231 to 6233). Further, as operating buttons, the cancellation button 608 and an acceptance button 611 are displayed as well as the other buttons that are same as FIGS. 12A and 12B. This purchase screen displays an inquiry result that is obtained when the ECM 22 of the TRM 12 inquires of a settlement server of the content provider 2, a credit card company, or the like about settlement means (6231 to 6233). When push-down of the acceptance button 611 is received in a state that the cursor is moved to one of the displayed settlement means, then, the ECM 22 proceeds with the settlement procedure with the settlement server. In the case where the settlement is performed by a server of a portal site for mobile phones such as an i-mode (registered trademark) server for example, the settlement procedure is advanced based on the subscriber information stored in the SIM 242 connected to the bearer 241.

FIG. 14B shows an example screen displaying processing of the content download after the end of the settlement processing. As shown in the figure, the context display area 620 informs the user of the state of the download, by displaying: a state message 6241 indicating that the download is in progress; an indicator 6242 showing a processing state of the license key; an indicator 6243 showing a processing state of the motion picture content; and a message 6244 showing that on-the-fly reproducing is possible. As operating buttons, a storing button 612 and the motion picture reproducing button 606 are displayed as well as the other buttons that are same as FIGS. 12A and 12B. When push-down of the storing button 612 is received, the screen transfers to the screen of FIG. 14C.

FIG. 14C shows an example screen at the time of storing the content onto the storage 74. The screen shown in FIG. 14C is different from the screen shown in FIG. 14B in that the rotation state indicator 6202 for an MD is displayed and the cancellation button 608 for stopping the storing of the content is displayed.

When push-down of the motion picture reproducing button 606 is received, on-the-fly reproducing is started. Next, will be described interface screens used for connecting a personal computer with the MCMP 1 when data stored in the personal computer is checked out to the MCMP 1 or data stored in the MCMP 1 are checked in to the personal computer. Here, “checked in” means return (transfer back) of data that have been checked out (transferred out) to an external device (here, the MCMP 1) to the personal computer as the source of checking out.

FIGS. 15A, 15B and 15C show examples of a display screen at the time of connecting with the personal computer. When connection with the personal computer, a screen shown in FIG. 15A is displayed first. The context display area 620 displays methods of transferring data out from or back to the PC. For example, the context display area 620 displays a method (6251, 6252) in which sound data or motion picture data are checked in according to operations on the MCMP 1 side, and a method (6253) in which sound data or motion picture data are checked out according to operations on the side of the personal computer while the MCMP 1 is in a standby state, for example. As operating buttons, the cancellation button 608 and the selection button 609 are displayed as well as the other buttons that are same as FIGS. 12A and 12B.

FIG. 15B shows a display screen for displaying processing in the case (6253 of FIG. 15A) where sound data or motion picture data are checked out while the MCMP 1 is in the standby state. The context display area 620 displays: a state message 6254 indicating that check out of the sound data from the personal computer to the track 3 is in progress; an indicator 6242 showing a processing state of the license key; and an indicator 6243 showing a processing state of the music content (sound data). As operating buttons, the cancellation button 608 and a button 413 assigned with no function are displayed as well as the other buttons that are same as FIGS. 12A and 12B.

FIG. 15C shows a display screen for displaying processing in the case (6252 of FIG. 15A) where motion picture data are checked in according operations on the side of the MCMP 1. This display screen is similar to FIG. 15B except that the context display area 620 displays a state message 6255 indicating that check in of the motion picture data in the track 2 is in progress.

Hereinabove, the embodiment of the present invention has been described. According to the processing of the present embodiment, sound data and motion picture data obtained separately from each other are stored onto a storage 74 being associated with each other, and the sound data and the motion picture data can be reproduced synchronously. Further, the motion picture reproducing unit 40 sends the synchronous reproducing start signal to the sound reproducing unit 50, and thereby the sound data and the motion picture data can be made coincident with each other in reproducing output start timing (beginning). Further, in the case where sound data and motion picture data are protected by different copyright protection techniques, license keys of the sound data and the motion picture data are managed independently of each other, and the sound data and the motion picture data are decrypted with the respective corresponding license keys. Thereby, the sound data and the motion picture data can be reproduced synchronously.

The present invention is not limited to the above-described embodiment, and can be modified variously within the scope of the invention. For example, in the above-described embodiment, when delays of decode processing in the motion picture decoder 42 accumulate and the decode processing termination time of a certain frame is past the estimated reproducing time of that frame, then, after decoding of that frame, the motion picture decoder 42 controls sending of that frame such that the frame is not sent to the display control unit 44 (namely, display is not updated). However, the present invention is not limited to this. When the decode processing termination time of a certain frame is past the estimated reproducing time of that frame, the motion picture decoder 42 may discard the next frame inputted after the frame in question without decoding it. In other words, the motion picture decoder 42 carries out control such that the next frame following the frame in question is neither decoded nor sent to the display control unit 44 (without updating display), but the motion picture decoder 42 decodes the next frame following the discarded frame. Thus, in the case of delay in the decode processing of the motion picture data, a frame is discarded to lower the frame rate and to synchronize reproducing output of the motion picture data with reproducing output of the sound data.

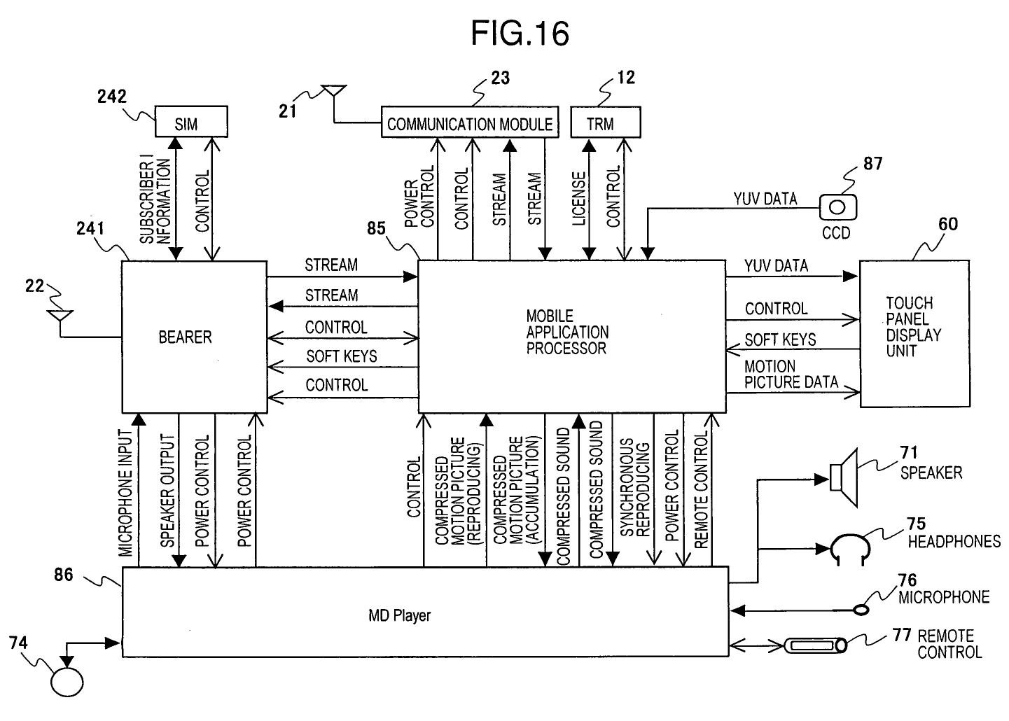

Further, the MCMP 1 can be used not only as a reproducing apparatus for sound data and motion picture data but also as a mobile phone. FIG. 16 shows a configuration of functional components (so-called chips) of the MCMP 1 in the case where the MCMP 1 is added with a mobile phone function. The MCMP 1 is different from FIG. 2 in that the MCMP 1 further includes with an image pickup pixels 87 such as a CCD (Charge Coupled Diode) camera or a CMOS image sensor.

In the case where the MCMP 1 is used as a mobile phone for transmitting voice only, the bearer 241 outputs communication partner's voice (which is received through the mobile phone network) together with a power control signal to the MD player 86. Then, the MD player 86 outputs the voice to the speaker 71 or the headphones 75. As a result, the user can listen to the communication partner's voice. On the other hand, user's voice is inputted from the microphone 76 through the MD player unit 86 to the bearer 241. The bearer 241 sends the voice (which is inputted from the microphone 76) to the communication partner through the mobile phone network. Here, when the MD player receives the voice of the communication partner from the bearer 241, a telephone number of the communication partner and a communication state may be received in addition and displayed on the display unit of the remote control 77.

Further, the bearer 241 may cooperate with the mobile application processor 85 and the MD player 86 such that the MCMP 1 functions as a mobile phone with a camera function. The mobile application processor 85 outputs yuv format data (which are recorded by the CCD 87 or the like) in the yuv format or the RGB format to the touch panel display unit 60, and sends the data as an image data stream to the bearer 241. As a result, the bearer 241 can sends the image recorded by the CCD camera or the like to a communication partner through the mobile phone network. Or, the image recorded by the CCD camera or the like may be simply outputted to the touch panel display unit 60, to make the MCMP 1 function as a digital camera.

As described above, according to the present invention, separately provided sound data and motion picture data can be made coincide with each other in their reproducing output timing with smaller discrepancy than the conventional technique. Further, sound data and motion picture data protected by respective different license keys can be reproduced.

1. A reproducing apparatus which synchronously reproduces motion picture data and sound data provided separately from each other, comprising:
a motion picture reproducing unit; and
a sound reproducing unit,
wherein:
said motion picture reproducing unit comprises: a motion picture decoder for decoding said motion picture data; and a display control unit which converts the motion picture data decoded by said motion picture decoder into an image signal for a display unit, and outputs the image signal to said display unit;
said sound reproducing unit comprises: a sound decoder which decodes said sound data; a data buffer which stores the sound data decoded by said sound decoder; and a sound conversion means which converts the decoded sound data stored in said buffer into a sound signal for a sound device, and outputs the sound signal to said sound device;
said display control means asserts a synchronous reproducing start signal according to output of said image signal corresponding to a top frame of said motion picture data; and
said sound conversion means starts output of said sound signal according to assertion of said synchronous reproducing start signal.

2. The reproducing apparatus according to claim 1, wherein:
said sound conversion means sends a sound synchronizing signal, i.e., a clock signal according to a sampling rate of said decoded sound data;
said motion picture decoder comprises: a means which measures a decode processing termination time of each of sequentially-inputted frames of said motion picture data; a means which calculates an estimated reproducing time of a frame based on a frame reproducing interval determined by said sound synchronizing signal and a number of frames of said motion picture data until the frame in question; wherein said motion picture decoder does not display a frame when the decode processing termination time of said frame is past the estimated reproducing time of said frame.

3. The reproducing apparatus according to claim 1, wherein:
said sound conversion means sends a sound synchronizing signal, i.e., a clock signal according to a sampling rate of said decoded sound data;
said motion picture decoder comprises: a means which measures a decode processing termination time of each of sequentially-inputted frames of said motion picture data; a means which calculates an estimated reproducing time of a frame based on a frame reproducing interval determined by said sound synchronizing signal and a number of frames of said motion picture data until the frame in question; wherein, when the decode processing termination time of a frame is past the estimated reproducing time of said frame, said motion picture decoder does not decode a frame inputted next to said frame and discards said non-decoded frame.

4. The reproducing apparatus according to claim 1, wherein:
said reproducing apparatus further comprises a license key storing means for storing a motion picture license key used for decrypting encrypted motion picture data and a sound license key used which decrypts encrypted sound data;
said motion picture reproducing unit further comprises a motion picture decryptor which decrypts said encrypted motion picture data by using the motion picture license key stored in said license key storing means, and outputs the decrypted motion picture data to said motion picture decoder; and
said sound reproducing unit further comprises a sound decryptor which decrypts said encrypted sound data by using the sound license key stored in said license key storing means, and outputs the decrypted sound data to said sound decoder.

5. The reproducing apparatus according to claim 4, wherein:
said license key storing means is a storing means having tamper resistance.

6. The reproducing apparatus according to claim 4, wherein:
said reproducing apparatus further comprises a storage medium control means which reads information from a storage medium storing said encrypted motion picture data, identification information of said motion picture license key, said encrypted sound data and identification information of said sound license key;
said motion picture decryptor reads the identification information of said sound license key from said storage medium through said storage medium control means, reads said motion picture license key from said license key storing means based on said identification information of the motion picture license key, and uses said motion picture license key to decrypt the encrypted motion picture data read from said storage medium through said storage medium control means; and
said sound decryptor reads the identification information of said sound license key from said storage medium through said storage medium control means, reads said sound license key from said license key storing means based on the identification information of the sound license key, and uses said sound license key to decrypt the encrypted sound data read from said storage medium through said storage medium control means.

7. The reproducing apparatus according to claim 1, wherein:
said motion picture reproducing unit further comprises an average calculation means which calculates a luminance average in a frame of the motion picture data, said frame being decoded by said motion picture decoder;
said sound conversion means sends a sound synchronizing signal; and
said display control means outputs said image signal to said display unit as long as said sound synchronizing signal is sent from said sound conversion means even when output from said motion picture decoder is ended, with said image signal being based on the luminance average calculated by said average calculation means.

8. A reproducing apparatus for reproducing a content having motion picture data and sound data provided separately from each other, comprising:
a motion picture reproducing unit;
a sound reproducing unit; and
a communication unit;
wherein:
said communication unit comprises: a license key obtaining means which sends identification information of a content to a content providing device through a network, to obtain a sound license key of sound data and a motion picture license key of motion picture data from said content providing device; and a license key storing means which stores the sound license key and the motion picture license key obtained by said license key obtaining means;
said motion picture reproducing unit comprises: a motion picture decryptor which decrypts encrypted motion picture data by using the motion picture license key stored in said license key storing means; a motion picture decoder which decodes the motion picture data decrypted by said motion picture decryptor; and a display control means which converts the motion picture data decoded by said motion picture decoder into an image signal for a display unit, and outputs the image signal to said display unit; and
said sound reproducing unit comprises: a sound decryptor which decrypts encrypted sound data by using the sound license key stored in said license key storing means; a sound decoder which decodes the sound data decrypted by said sound decryptor;
and a sound conversion means which converts the sound data decoded by said sound decoder into a sound signal for a sound device, and outputs the sound signal to said sound device.

9. The reproducing apparatus according to claim 8, wherein:
said reproducing apparatus further comprises a storage medium control means which controls read and write of information to a storage medium; wherein:
said storage medium stores identification information of a content, and encrypted sound data and motion picture data as constituents of said content;
said license key obtaining means reads the identification information of the content from said storage medium through said storage medium control means, sends the read identification information to said content providing device, to obtain the sound license key of the sound data and the motion picture license key of the motion picture data from said content providing device;
said motion picture decryptor reads the encrypted motion picture data from said storage medium through said storage medium control means, and decrypts the encrypted motion picture data by using the motion picture license key stored in said license key storing means; and
said sound decryptor reads the encrypted sound data from said storage medium through said storage medium control means, and decrypts the encrypted sound data by using the sound license key stored in said license key storing means.

10. The reproducing apparatus according to claim 9, wherein:
said communication unit further comprises a content obtaining means which sends identification information of a content to said content providing device, obtains at least sound data or motion picture data as a constituent of said content from said content providing device, and stores the obtained sound data or motion picture data onto said storage medium through said storage medium control means.

11. The reproducing apparatus according to claim 8, wherein:
said motion picture data are motion picture data taken by a street camera installed in a street or a picturesque place, and have a same reproducing time as a reproducing time of said sound data.

12. A reproducing method for synchronously reproducing motion picture data and sound data provided separately from each other, comprising:
a step in which said motion picture data are decoded, the decoded motion picture data are converted into an image signal for a display unit and outputted to said display unit, and said sound data are decode, the decoded sound data are stored into a data buffer, and the decoded and stored sound data are converted into a sound signal for a sound device and outputted to said sound device;
wherein:
in said step, a synchronous reproducing start signal is asserted at a time of outputting said image signal corresponding to a top frame of the motion picture data, and output of said sound signal is started according to assertion of said synchronous reproducing start signal.

13. A reproducing method for reproducing a content having motion picture data and sound data provided separately from each other, comprising:
a step of sending identification information of the content to a content providing device through a network, and obtaining a sound license key of the sound data and a motion picture license key of the motion picture data from said content providing device, with said sound data and said motion picture data being constituents of said content;
a step of storing said sound obtained license key and motion picture license key;
a step of decrypting encrypted motion picture data by using said stored motion picture license key, decoding said decrypted motion picture data, and converting said decoded motion picture data into an image signal for a display unit to output the image signal to said display unit, and decrypting encrypted sound data by using said stored sound license key, decoding said decrypted sound data, and converting said decoded sound data into a sound signal for a sound device to output the sound signal to said sound device.
